(19) United States
(12) Patent Application Publication
(10) Pub. No.: US 2013/0179648 A1
(43) Pub. Date: Jul. 11, 2013

(54) MANAGEMENT APPARATUS AND MANAGEMENT METHOD FOR COMPUTER SYSTEM

(71) Applicants: Tadashi Yagame, Yokohama (JP); Tatsundo Aoshima, Yokohama (JP); Toshio Sato, Fujisawa (JP)

(72) Inventors: Tadashi Yagame, Yokohama (JP); Tatsundo Aoshima, Yokohama (JP); Toshio Sato, Fujisawa (JP)

(73) Assignee: Hitachi, Ltd.

(21) Appl. No.: 13/574,959

(22) PCT Filed: Jan. 5, 2012
(86) PCT No.: PCT/JP2012/050074

§ 371 Date: Jul. 24, 2012

(51) Int. Cl. G06F 12/00

(52) U.S. Cl. 711/156; 711/E12.001

(57) ABSTRACT

To provide a user of a virtual volume with a performance commensurate with a fee. A management apparatus 4 stores fee information by tier 4H for managing, for each of a plurality of storage tiers, a fee required for using storage regions of the storage tiers. The management apparatus 4 stores a predetermined fee plan information item 4F of a plurality of prepared fee plan information items, the predetermined fee plan information item being associated with a host computer. An arrangement controller 4A of the management apparatus 4 associates logical storage regions with the storage regions of the plurality of storage tiers on the basis of the predetermined fee plan information item 4F, the fee information by tier 4H, and a frequency of access 4G by the host computer to the logical storage regions.

### TECHNICAL FIELD

The present invention relates to a management apparatus and a method for a computer system.

### BACKGROUND ART

As virtualization technology of a storage apparatus, there is a storage apparatus for creating a pool (hierarchical pool) using a plurality of types of storage devices of different performances (PTL 1). In the hierarchical pool, storage regions of virtual logical volumes are allocated to a data unit called “pages.” Also, in the hierarchical pool, a storage device serving a page arrangement destination is switched on a regular basis in accordance with access characteristics (the number of I/Os, etc.) per unit time of a page unit. For example, a high-performance storage device is preferentially allocated to a page having high access characteristics. Therefore, when designing a constitution satisfying system performance/capacity requirements, a necessary capacity of the high-performance storage device becomes smaller, compared to when allocating data from a single type of storage device. This enables reduction of storage costs.

As server virtualization technology, there is technology for creating a plurality of virtual machines on a single physical (or logical) disk device (see NPL 1, for example). A single physical (or logical) disk can be shared by the plurality of virtual machines, by creating a dedicated region (virtual disk) for each of the virtual machines on the single physical (or logical) disk device.

### CITATION LIST

### Patent Literature

[PTL 1]
Japanese Patent Application Publication No. 2007-066259
[NPL 1]
Vmware vSphere, http://www.vmware.com/jp/products/vsphere/

### TECHNICAL PROBLEM

The use of a virtual environment in a company has been increasing in recent years. In the virtual environment, usually a plurality of virtual disks are created on a single physical volume or logical volume in order to run a plurality of virtual machines.

These virtual machines are sometimes lent out with compensation to companies or ordinary users. Budgets paid by the users of the virtual machines for borrowing the virtual machines are limited.

The users wish to use the virtual machines of as high performance as possible with the limited budgets and to arrange data of high performance in high-speed storages as much as possible. In order to satisfy these needs, considered is a method for dynamically arranging pages to virtual logical volumes by using the hierarchical pool described in the prior art.

Nevertheless, the conventional technologies only switch the storage device serving as the page arrangement destination in units of virtual logical volumes. Thus, in the case where the plurality of virtual machines are arranged on a single virtual logical volume, a storage of an appropriate performance cannot be provided to each virtual machine in accordance with the budget of each virtual machine.

### SUMMARY OF INVENTION

The present invention was contrived in view of these problems, and an object thereof is to provide a management apparatus for a computer system and a management method for the computer system, the apparatus and method being capable of providing virtual logical volume of an appropriate performance, within a range of fees configured for a host computer.

### SOLUTION TO PROBLEM

In order to solve the aforementioned problems, a management apparatus according to the present invention is a management apparatus for managing a computer system including a host computer and a storage apparatus, the storage apparatus having a virtual logical volume to be provided to the host computer and a pool having a plurality of storage tiers of different performances, and storage regions of the plurality of storage tiers being associated with a plurality of logical storage regions forming the virtual logical volume, the management apparatus comprising: a tier fee storage part for storing fee information by tier, which manages, for each of the storage tiers, a fee required for using the storage regions of the plurality of storage tiers; a fee plan information storage part for storing a predetermined fee plan information item of a plurality of prepared fee plan information items, the predetermined fee plan information item being associated with the host computer; and an arrangement controller that associates the storage regions of the plurality of storage tiers with the logical storage regions on the basis of the predetermined fee plan information item, the fee information by tier, and a frequency of access by the host computer to the logical storage regions.

The host computer can be constituted as a virtual host computer that is virtually provided in plurality on a single physical computer, and the virtual host computers can share the virtual logical volume.

The management apparatus may further comprise a pool state monitoring part for monitoring a state of the pool and displaying a monitoring result.

The features of the present invention described above can be combined in various other ways. In addition, the present invention can be interpreted as a computer program. The computer program is installed into a computer via a communication medium or recording medium.

### BRIEF DESCRIPTION OF DRAWINGS

FIG. 1 is an explanatory diagram showing an entire outline of the present embodiment.

FIG. 2 is a diagram showing an entire constitution of a computer system.

FIG. 3 is an explanatory diagram showing a relationship between a function and a table.

FIG. 4 is an explanatory diagram showing a relationship among a virtual volume, pool, and storage device.

FIG. 5 is an example of a screen used when changing a performance plan.

FIG. 6 is an example of a screen used when changing a pool constitution.

FIG. 7 is an example of another screen used when changing the pool constitution.

FIG. 8 is a table for managing a constitution and capacity of the pool.

FIG. 9 is a table for managing a constitution and capacity of a pool volume.

FIG. 10 is a table for managing a constitution and capacity of a virtual volume.

FIG. 11 is a table for managing a constitution and capacity of a virtual machine.

FIG. 12 is a table for managing constitution information of a page.

FIG. 13 is a table for managing information on a pool performance.

FIG. 14 is a table for managing information on performance of the virtual machine.

FIG. 15 is a table for managing information on a page performance.

FIG. 16 is a table for managing information on a performance of a storage device by pool tier.

FIG. 17 is a table for managing information on a performance of a pool volume.

FIG. 18 is a table for managing an operational cost of the storage device by pool tier.

FIG. 19 is a table for managing a page rearrangement destination.

FIG. 20 is a table for managing information on a performance plan of the virtual machine.

FIG. 21 is a table for managing information on the performance plan.

FIG. 22 is a table for managing a fee by pool tier.

FIG. 23 is a table for information on a change in the performance plan.

FIG. 24 is a table for managing each threshold related to a performance and capacity of the pool.

FIG. 25 is a flowchart showing a process in which an agent collects information.

FIG. 26 is a flowchart showing a process for displaying information on an in-use virtual machine.

FIG. 27 is a flowchart showing a process for displaying a performance plan change screen.

FIG. 28 is a flowchart showing a process for predicting a response performance.

FIG. 29 is a flowchart showing a process for calculating a fee after the change of the performance plan.

FIG. 30 is a flowchart showing a process for requesting for the change of the performance plan.

FIG. 31 is a flowchart showing a process for displaying pool information.

FIG. 32 is a flowchart showing a process for predicting a use capacity.

FIG. 33 is a flowchart showing a process for predicting access characteristics (IOPS).

FIG. 34 is a flowchart showing a process for predicting the fee.

FIG. 35 is a flowchart showing a process for calculating the page rearrangement destination.

FIG. 36 is a flowchart showing a process for displaying a pool constitution change screen.

### DESCRIPTION OF EMBODIMENTS

An embodiment of the present invention is now described hereinafter with reference to the drawings. Various types of information are described hereinafter using “xxx table(s)”; however, these types of information may be described using data structures other than the tables. Such a term as “xxx table (s)” can often be referred to as “xxx information” in order to indicate that the various types of information are not dependent on the data structures.

In the descriptions below, a process is explained using a term “program” as the subject of the sentence. The program is executed by a processor (e.g., a CPU (Central Processing Unit)) to execute a certain process by appropriately using a storage resource such as a memory and a communication interface device such as a communication port. Thus, the subject of the sentence describing the process may be “processor.” The processor may have dedicated hardware in addition to the CPU. A computer program may be installed from a program source into a computer. The program source may be, for example, a program distribution server or a storage medium.

Elements such as pool volumes can be identified with identifiers (ID), numbers, names, and the like.

The embodiment is described hereinbelow. The present invention is not limited to the embodiment described below, and various application examples corresponding to the idea of the present invention are encapsulated in the technical scope of the present invention. The number of components may be one or more, unless otherwise specified.

As will be described later, in the present embodiment, a page unit cost is configured for each of storage tiers forming a pool, and a fee plan is configured for each of virtual machines sharing a virtual logical volume (“virtual volume,” hereinafter). In the present embodiment, a page arrangement destination (also referred to as “rearrangement destination”) is determined in order to obtain as high response performance as possible within a range of the fee plans.

Thus, in the present embodiment, even when a plurality of virtual machines are run on a single virtual volume in a storage that has a dynamic page rearrangement function, each of the virtual machines can be provided with a storage of appropriate performance, within a budget allocated to each virtual machine.

In the present embodiment, a screen for changing the fees for the virtual machines is provided to users who use the virtual machines. Accordingly, the storage with an appropriate performance can be provided in accordance with a business schedule (such as when the performance is needed for a certain period of time) of each of the users who uses the virtual machines. The screen can display a change in the storage performance with respect to a payment amount and use capacity, so that the virtual users can confirm cost-effectiveness before changing the fees.

According to the present embodiment, a current state and predictive value with respect to a pool performance and pool capacity can be displayed in chronological order to a storage administrator (“administrator,” hereinafter). The administrator can easily determine whether the constitution of the pool needs to be changed or not. This way, efficiency and usability of management tasks can be improved. Further, in the present embodiment, a candidate for a pool volume that can be added to the pools and/or a candidate for a pool volume that can be deleted from the pool can be presented to the administrator, so that the administrator can easily make changes in the constitution of the pool.

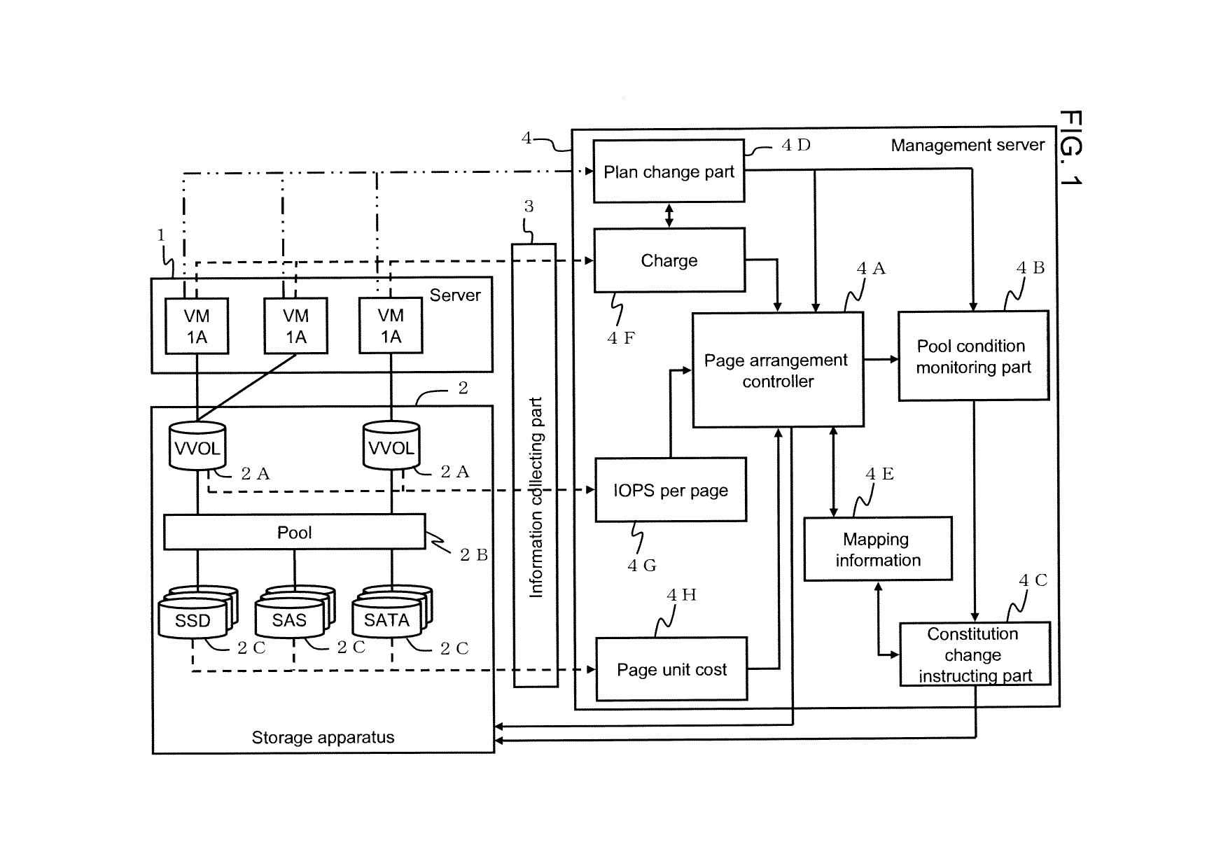

FIG. 1 is an explanatory diagram showing the entire outline of the present embodiment. As described above, the constitution shown in FIG. 1 is merely an example; thus, the present invention does not need the whole constitution shown in FIG. 1.

A computer system has, for example, one or more virtualization servers 1, one or more storage apparatuses 2, one or more information collecting parts 3, and one management server 4.

The virtualization server 1 is provided with a plurality of virtual machines 1A. Each of these virtual machines 1A corresponds to “host computer.” Each of the virtual machines 1A uses a virtual volume 2A of the storage apparatus 2.

The storage apparatus 2 has, for example, one or more virtual volumes 2A, one or more pools 2B, and a plurality of types of storage devices 2C. The virtual volume 2A is a logical volume generated virtually and has an actual data storage destination in a storage region (actual page) inside the pool 2B. The actual page is allocated to a logical storage region (logical page or virtual volume) of the virtual volume 2A in response to a write access of the virtual machine 1A.

The pool 2B manages the actual page to be associated with the virtual volume 2A. The pool 2B is provided with a plurality of storage tiers, such as high-performance tiers, medium-performance tiers, and low-performance tiers. One or more pool volumes coherent with performance conditions of the storage tiers are disposed in each of the tiers. A high-performance pool volume is constituted by a high-performance storage device (e.g., SSD) 2C. A medium-performance pool volume is constituted by a medium-performance storage device (e.g., SAS) 2C. A low-performance pool volume is constituted by low-performance storage device 2C (e.g., SATA).

When using a hard disk device as each of the storage devices 2C, for example, an FC (Fibre Channel) disk, SCSI (Small Computer System Interface) disk, SATA disk, ATA (AT attachment) disks, SAS (Serial Attached SCSI) disk or the like can be used. In addition to the hard disk device, for example, a flash memory (SSD), FeRAM (Ferroelectric Random Access Memory), MRAM (Magentoresistive Random Access Memory), phase-change memory (Ovonic Unified Memory), RRAM (Resistance RAMT™) or the like can be used.

The information collecting part 3 collects predetermined information (constitution information, performance information, etc.) from the virtualization server 1 and the storage apparatus 2 and transmits the collected information to the management server 4. The information collecting part 3 may be provided inside the management server 4 or as a computer separately from the management server 4.

The management server 4 is a computer for managing the computer system. The management server 4 may be constituted by one computer or a plurality of computers. A user interface part for allowing for the exchange of information between the management server 4 and the user or administrator may be provided in the management server 4 or in a client terminal connected to the management server 4.

The management server 4 has, for example, a page arrangement controller 4A, a pool state monitoring part 4B, a constitution change instructing part 4C, and a plan change part 4D. Further, the management server 4 stores mapping information 4E, a fee 4F, an IOPS (Input Output Per Second) per page 4G, and a page unit cost 4H.

The user previously associates the virtual machine 1A with a performance plan indicated as “fee plan information.” Hereinafter, the performance plan is simply referred to as “plan.” For example, a plurality of performance plans, such as a platinum plan, gold plan, silver plan, and bronze plan, are prepared in accordance with a performance rank desired by the user.

In the high plan (e.g., the platinum plan), a large number of pages of high-response performance storage tiers can be used. In the low plan (e.g., the bronze plan), a large number of pages of low-response performance storage tiers are used. In the middle plans (e.g., the gold plan, the silver plan), pages of each storage tier can be used in the middle between the high plan and the low plan. The fees (budget amounts) to be paid by the user are defined for each performance plan. The fee becomes higher as the plan becomes higher, and the fee becomes lower as the plan becomes lower. For instance, an amount per unit time can be configured as the fee defined for each performance plan.

The unit cost 4H is previously configured in a page within each storage tier (simply referred to as “tier,” hereinafter). The page unit cost 4H, an example of “fee information by tier,” is configured as a unit cost per unit time, such as a fee for 1-day use of a certain page. When the page is used within a unit time, the unit cost is fixed, no matter regardless of the number of accesses. As described hereinafter, however, the page unit cost may be increased when the number of accesses exceeds a certain threshold, in order to ensure equality between a virtual machine 1A that has a large number of accesses and a virtual machine 1A that has a low number of accesses.

The page arrangement controller 4A functioning as “arrangement controller” calculates a page of a storage tier for storing data of the virtual volume 2A, based on the fees (i.e., budget amounts) shown by the performance plan configured for each virtual machine 1A, the page unit costs 4H, and the access frequency (IOPS) 4G per page.

The page rearrangement controller 4A arranges the pages of high access frequency in the tiers of as high performances as possible, and the pages of low access frequency in the tiers of low performances. High performance and low performance described here vary according to the rank of the fee (budget amount). The page arrangement controller 4A arranges the pages in the tiers according to the access frequencies, such that the highest response performance is obtained within the range of the fees paid by the virtual machine 1A. The page arrangement controller 4A calculates the page arrangement destination and converts the mapping information 4E. The mapping information 4E is information for managing a correlation between the logical page of the virtual volume 2A and the actual page of the pool 2B.

The user can change the performance plan thereof using the plan change part 4D. For instance, when the user wishes to enhance the response performance to improve business efficiency during a busy period, the user can upgrade the current performance plan. When the user wishes to save the fee in a slow period, the user can downgrade the current performance plan.

In this manner, the storage apparatus 2 is shared by the plurality of virtual machines 1A. The virtual machines 1A can share a single virtual volume 2A. The performance plan information of each virtual machine 1A is not necessarily constant and changes due to the user's circumstances or the situation of the business.

Therefore, the performances (response performances, capacities) required for the pool 2B of the storage apparatus 2 are not constant and keep changing. For example, when a plurality of users wish to shift their performance plans to the high performance plan or wish to increase their use capacities, the current pool constitution might not be able to respond to such demands.

In the present embodiment, therefore, the pool state monitoring part 4B monitors a usage state of the pool 2B. The pool state monitoring part 4B can also monitor the usage state of the pool 2B with due consideration of a change of a performance plan.

The pool state monitoring part 4B notifies the administrator of a monitoring result. After confirming the monitoring result, the administrator can instruct the storage apparatus 2 to change the constitution of the pool 2B, by using the constitution change instructing part 4C. Examples of changing the constitution of the pool 2B include: adding capacity to the high-performance storage tiers and reducing capacity from the low-performance storage tiers. The constitution change instructing part 4C can present to the administrator a list of pool volumes that can be added to the storage tiers and/or a list of pool volumes that can be eliminated from the storage tiers.

### Example 1

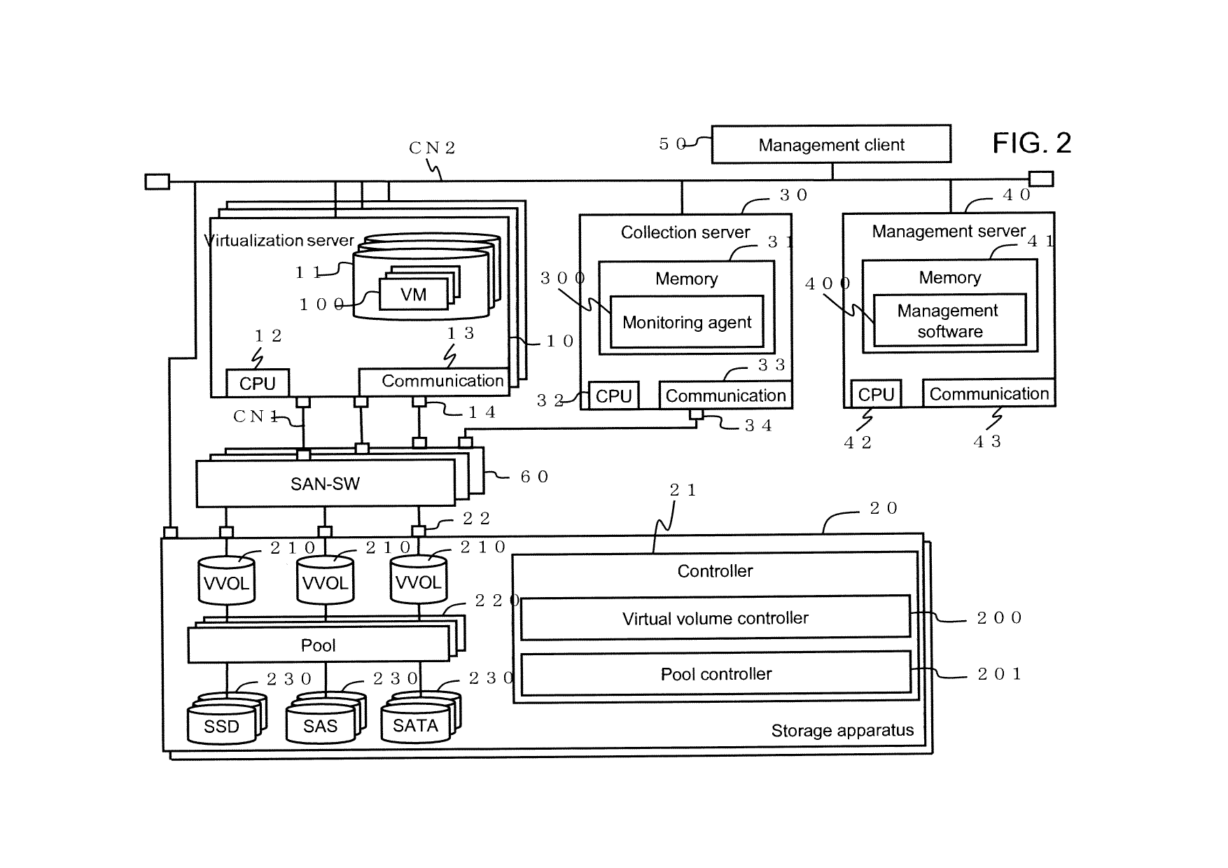

FIG. 2 shows the entire constitution of the computer system of the present example. The computer system has, for example, a plurality of virtualization servers 10, a plurality of storage apparatuses 20, at least one information collection server (“collection server” in the diagram) 30, at least one management server 40, and at least one management client 50, and a plurality of switch devices 60.

A correlation between FIG. 1 and FIG. 2 is now described. The virtualization servers 10 correspond to the servers 1, the storage apparatuses 20 to the storage apparatuses 2, the information collection server 30 to the information collecting part 3, and the management server 40 to the management server 4. Virtual volumes 210, described hereinafter, correspond to the virtual volumes 2A, a pool 220 to the pool 2B, storage devices 230 to the storage devices 2C, and virtual machines 100 to the virtual machines 1A.

Communication structures are now described. Each of the virtualization servers 10 and each of the storage apparatuses 20 are connected to each other via each of the switch devices 60 so as to be able to perform two-way communication. Each of the virtualization servers 10 and each of the storage apparatuses 20 communicate with each other via a communication network CN1 such as a FC_SAN (Fibre Channel Storage Area Network) or IP_SAN (Internet Protocol_SAN).

Each of the virtualization servers 10, each of the storage apparatuses 20, the information collection server 30, the management server 40, and the management client 50 are connected to one another via a management communication network CN2 such as a LAN (Local Area Network). Note that the I/O communication network CN1 and the management communication network CN2 may be integrated into a common communication network.

The constitution of one of the virtualization servers 10 is now explained. The virtualization server 10 is a computer capable of generating the plurality of virtual machines 100 on a single physical server. The virtualization server 10 has, for example, a data store 11, a CPU 12, and a communication device 13. The data store 11 is for storing the plurality of virtual machines 100. The communication device 13 communicates with the communication networks CN1 and CN2 through a communication port 14.

The constitution of one of the storage apparatuses 20 is now described. The storage apparatus 20 has, for example, a controller 21 and a communication port 22. The storage apparatus 20 communicates with the communication networks CN1 and CN2 through a communication port 22.

The controller 21 controls operations of the storage apparatus 20. The controller 21 has, for example, a virtual volume controller 200 for controlling the virtual volumes 210, and a pool controller 201 for controlling the pool 220. These functions 200 and 201 are realized by allowing a CPU, not shown, to execute a predetermined computer program stored in a memory, not shown. Note that the term “memory” described in the present specification is not limited to a so-called main memory but includes an auxiliary storage device.

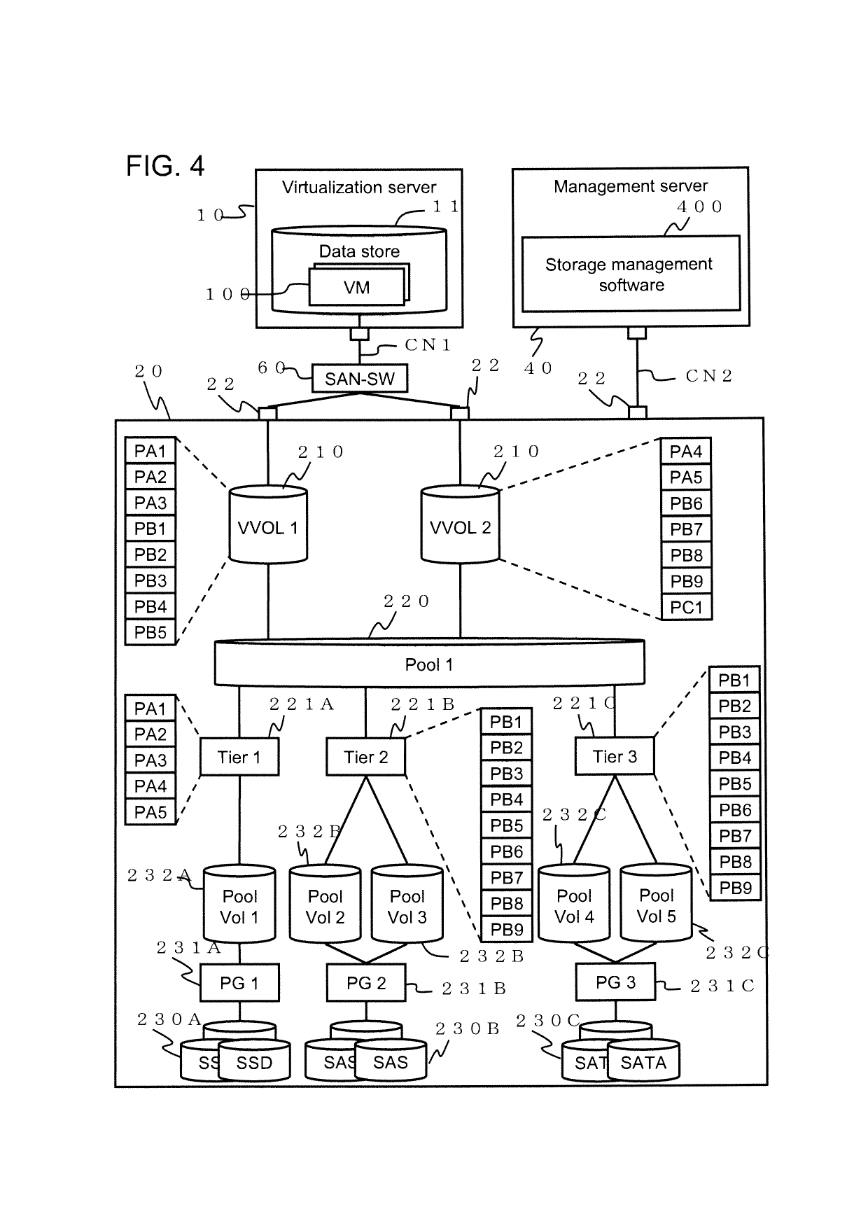

The storage apparatus 20 has a plurality of virtual volumes 210, a plurality of pools 220, and a plurality of types of storage devices 230. A relationship among the virtual volumes 210, pools 220, and storage devices 230 is described hereinafter with reference to FIG. 4.

The information collection server 30 is a server for collecting information stored in the computer system and transmitting the information to the management server 40. The information collection server 30 has, for example, a memory 31, CPU 32, communication device 33, and communication port 34. The communication device 33 communicates with the communication networks CN1 and CN2 through the communication port 34.

A monitoring agent program (“monitoring agent,” hereinafter) 300 is stored in the memory 31. The monitoring agent 300 collects predetermined information on the constitutions and performances from the virtualization server 10 and the storage apparatus 20 to be monitored, and then transmits the predetermined information to the management server 40 via the communication network CN2. Note that the information collection server 30 and the management server 40 may be constituted into a single server.

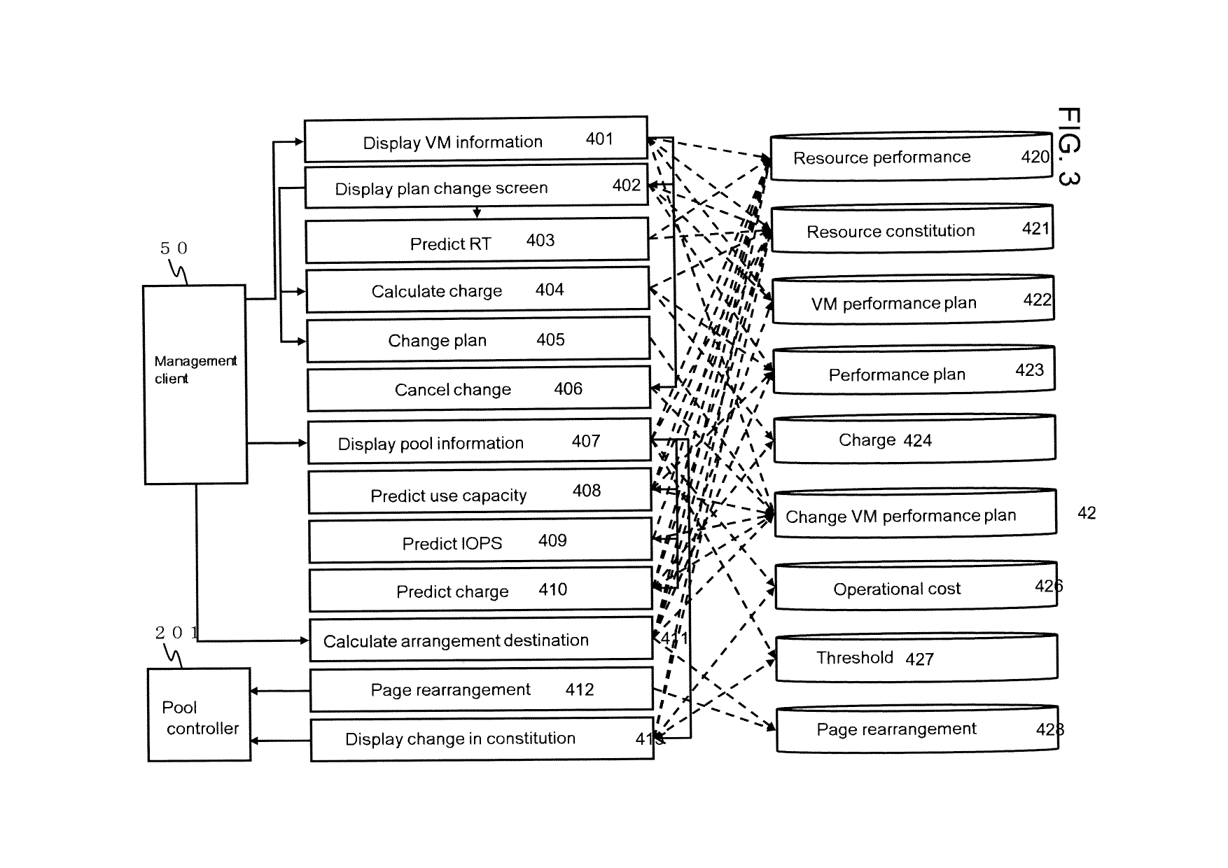

The management server 40 manages the constitution of the storage apparatus 20 based on a state of the computer system. The management server 40 has, for example, a memory 41, CPU 42, and communication device 43. A management software group 400 and a management table group for managing the storage apparatus 20 are stored in the memory 41. The entire outlines of the management software group and the management table group are described hereinafter with reference to FIG. 3. The management software group and the management table group are further described hereinafter in detail. Functions of the management server 40 may be provided within the storage apparatus 20.

The management client 50 is a computer for giving instructions to the management server 40 and displaying information extracted from the management server 40. The management client 50 can be constituted as a computer terminal having a communication device, an arithmetic processor, a memory device, and a user interface device, such as a personal computer, a portable information terminal, and a mobile phone.

The user interface device has an information output device for outputting information from the management client 50, and an information input device for inputting information into the management client 50. Examples of the information output device include a display device, a synthetic audio output device, and a printer. Examples of the information input device include pointing devices such as a touch panel, keyboard switch, and mouse, and an audio instruction device.

The administrator accesses the management server 40 via the management client 50 to give instructions to the management server 40 or confirm a screen received from the management server 40. Note that the management client 50 may be removed, and the user interface device may be provided in the management server 40.

FIG. 3 is an explanatory diagram showing the entire outlines of the management software group 400 and the management table group of the management server 40. For convenience, the formal names are omitted in FIG. 3.

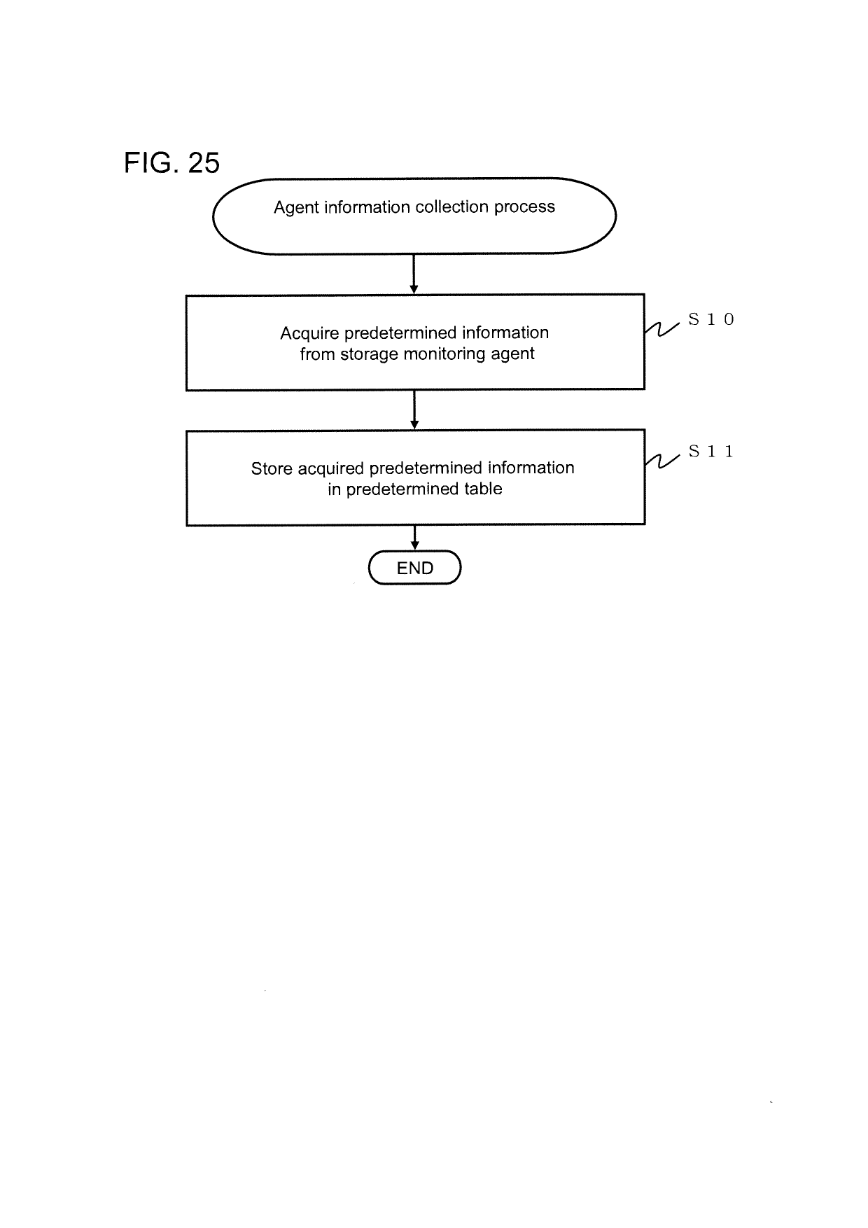

In FIG. 3, an agent information collecting part, which is described hereinafter with reference to FIG. 25, is omitted. The agent information collecting part is a function for collecting information via the monitoring agent 300 and storing the collected information in a resource performance table 420 and resource constitution table 421.

The monitoring agent 300 is started on a regular basis according to a programmed schedule or time. The monitoring agent 300 is also started at the request of the management software 400. The started monitoring agent 300 acquires information on the constitutions and capacities and/or the performance information from the devices to be monitored (the virtualization server 10 and the storage apparatus 20) and the software (the virtual machines 100, virtual volume controller 200, pool controller 201, etc.).

The term “resource” described in the present specification is a generic term used to refer to various types of hardware forming a SAN environment, components of these types of hardware, computer programs executed by these types of hardware, and logical components of these computer programs.

Examples of the various types of hardware include the storage apparatus 20 and the virtualization server 10. Examples of the physical or logical components of these types of hardware include logical volumes 232, the virtual volumes 210, the storage devices 230, and the virtual machines 100. Examples of the programs that are executed by these types of hardware include business processing software and database management systems. Examples of the logical components of the programs include file systems and device files.

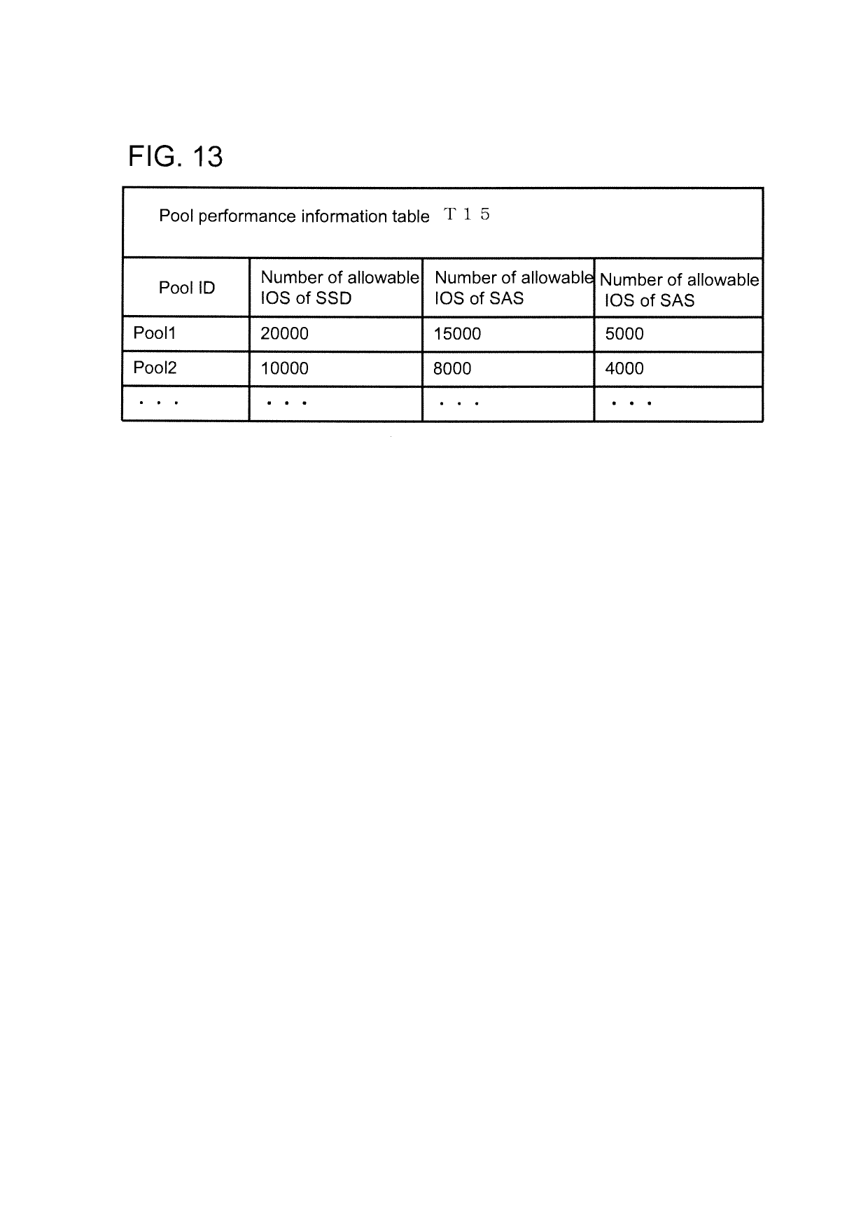

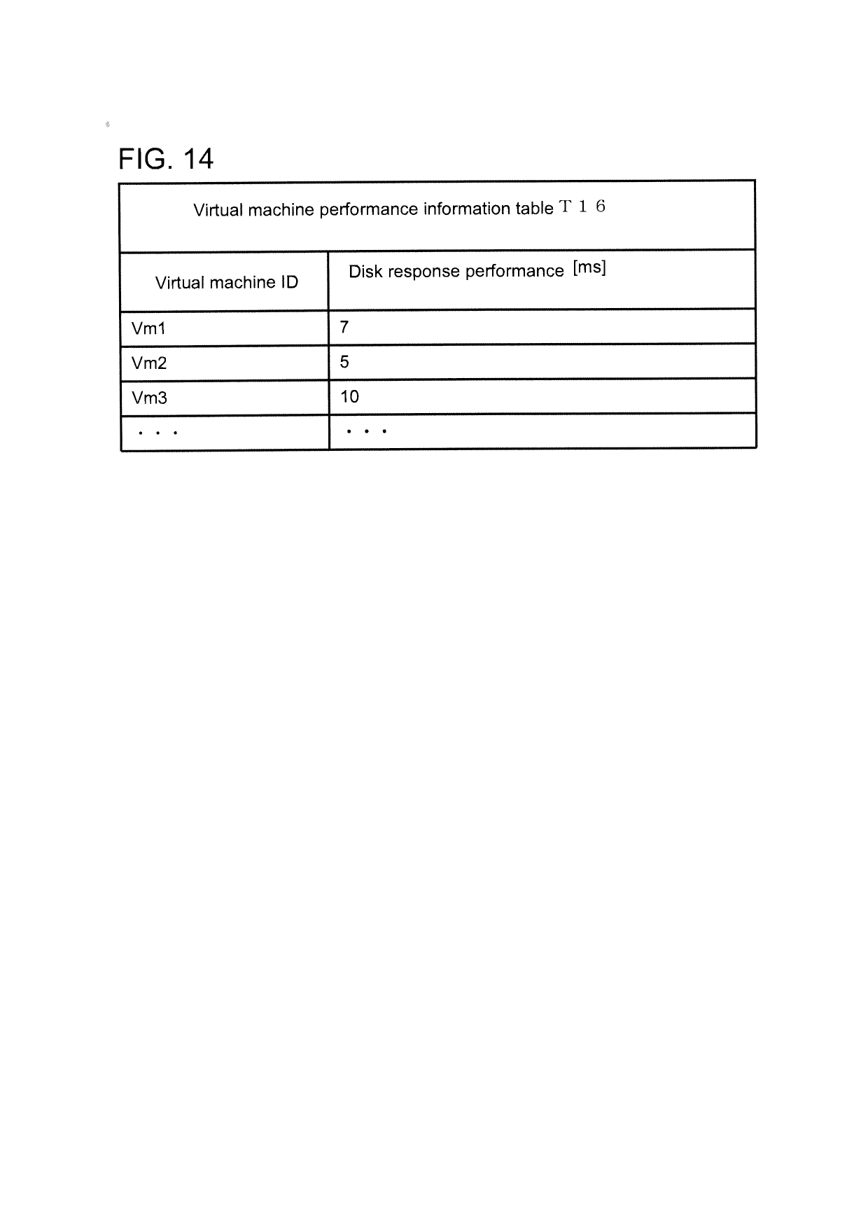

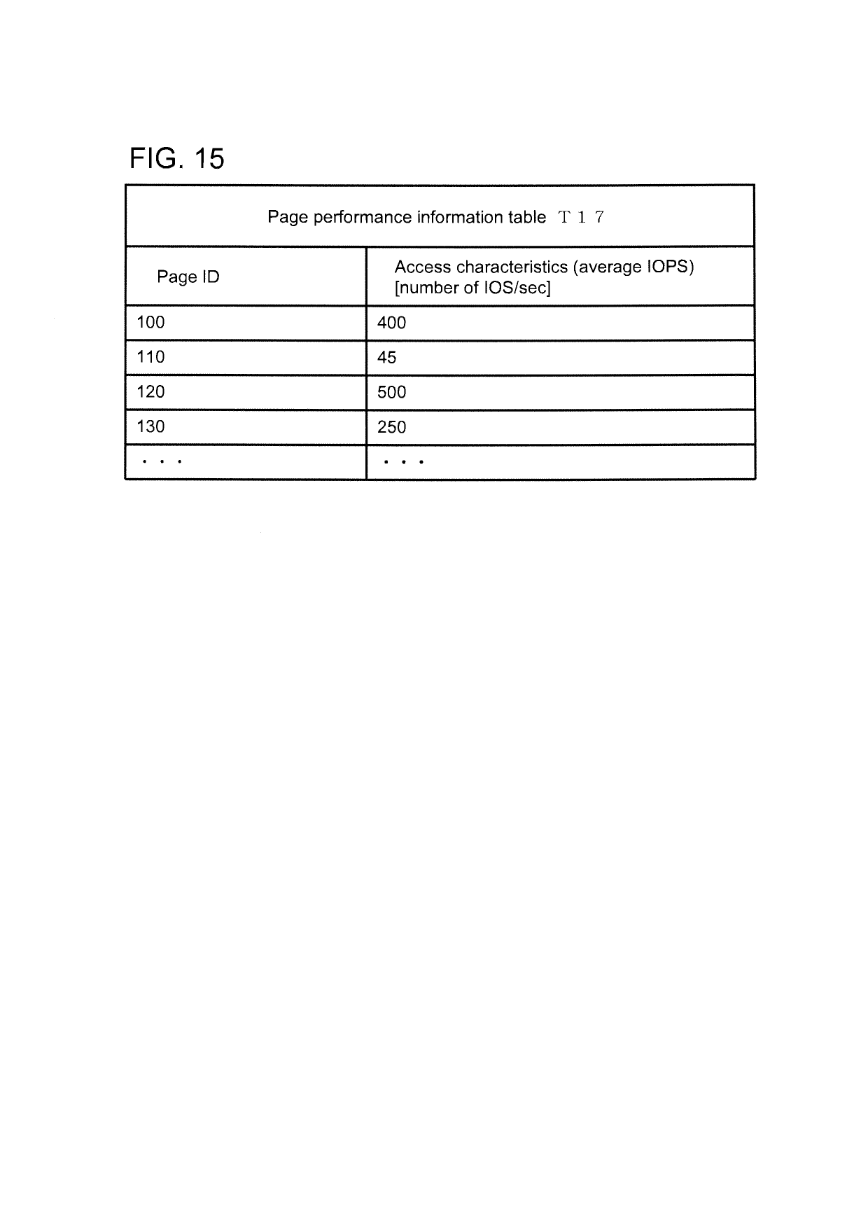

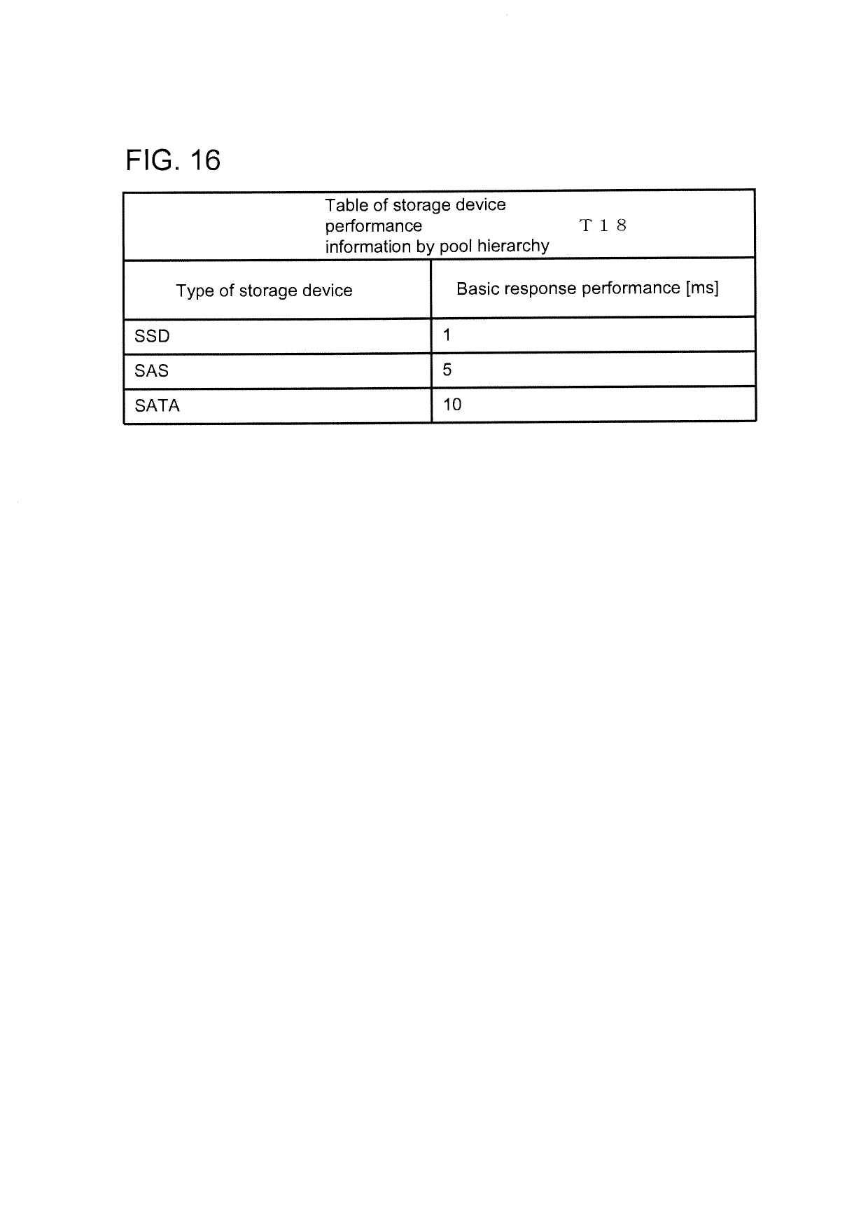

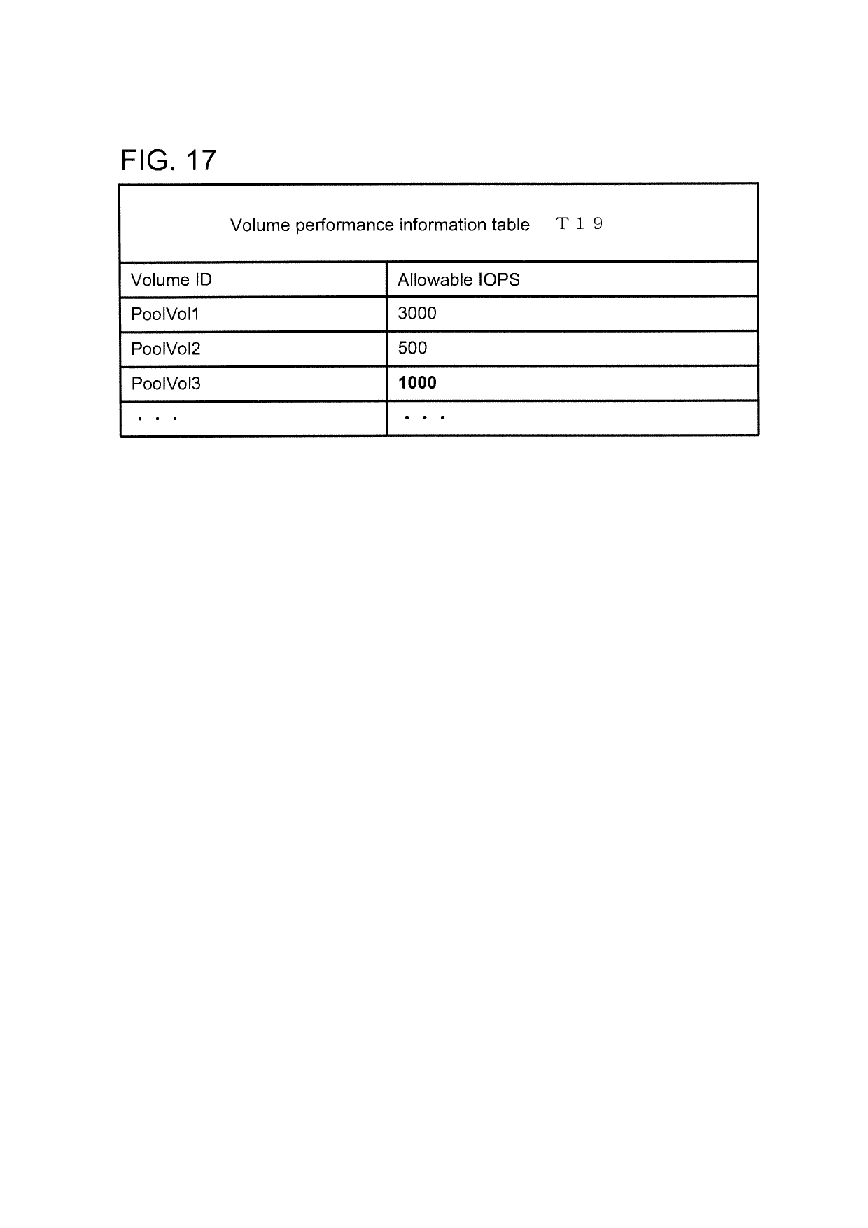

The resource performance information 420 is performance information collected by the agent information collecting part (FIG. 25) and related to a resource to be registered. The resource performance information 420 includes, for example, a pool performance information table T15 (FIG. 13), a virtual machine performance information table T16 (FIG. 14), a page performance information table T17 (FIG. 15), a table T18 of storage device performance information by pool tier (FIG. 16), and a volume performance information table T19 (FIG. 17). These tables are described hereinafter.

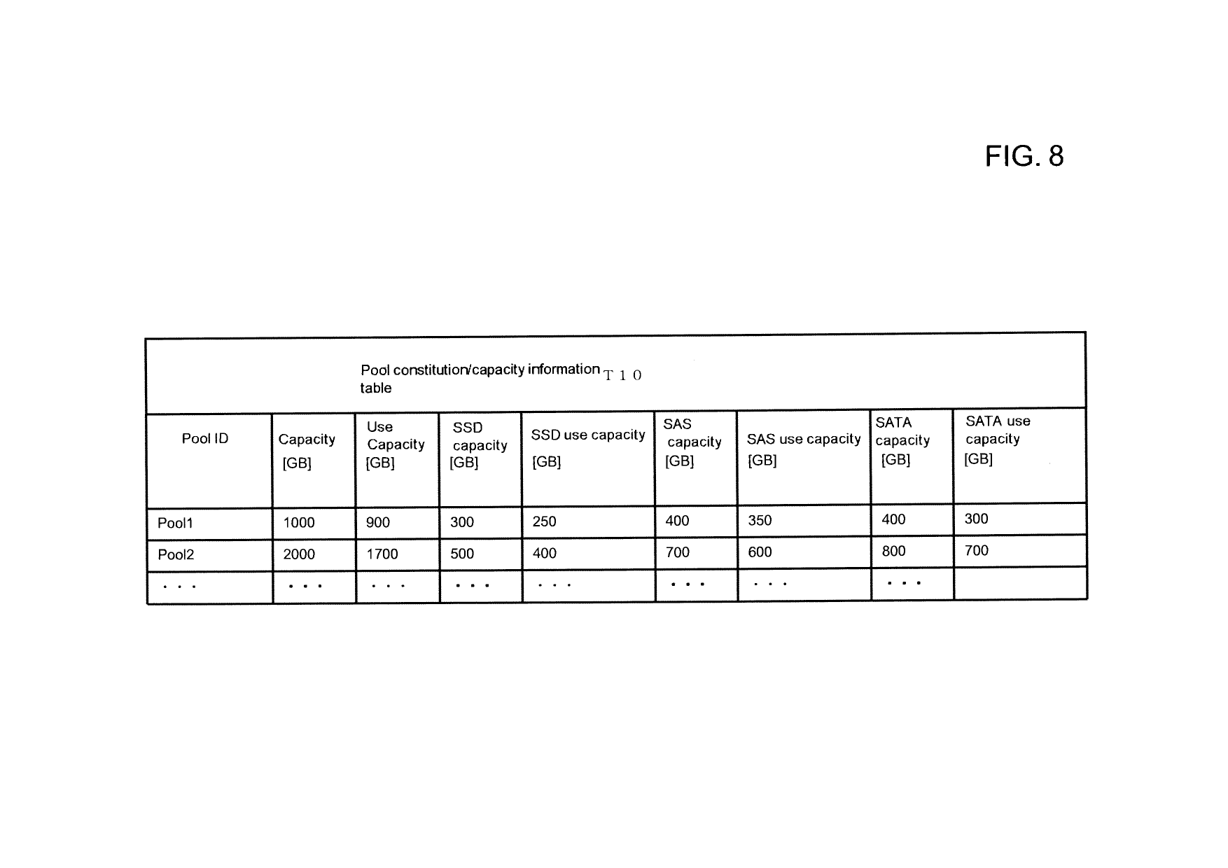

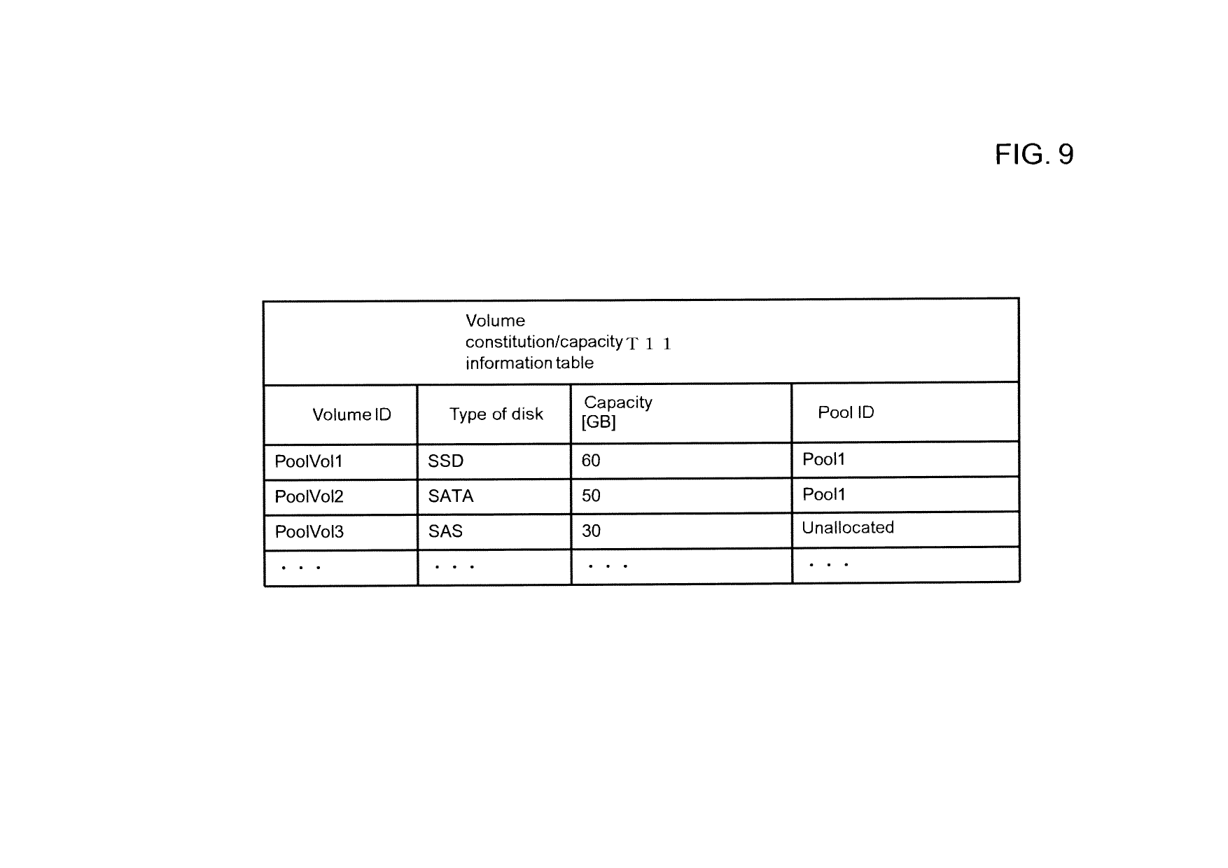

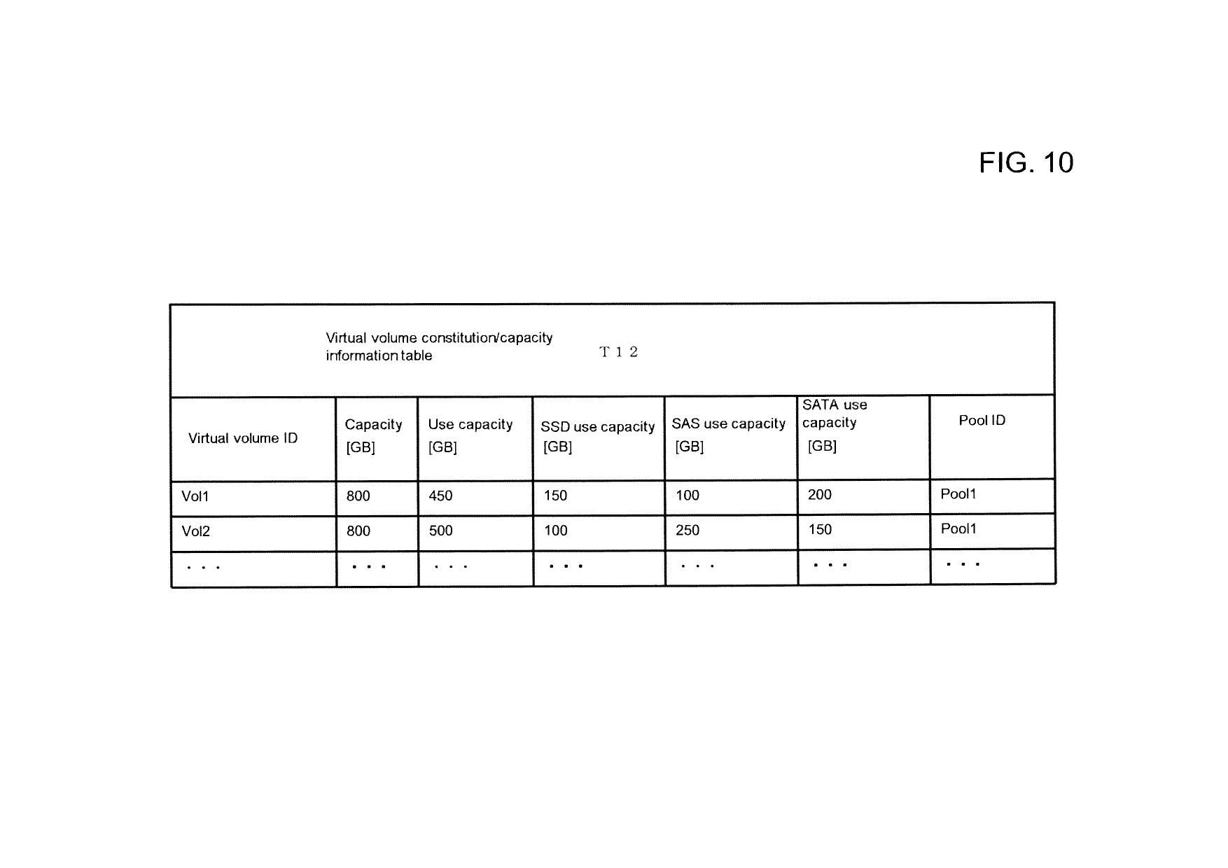

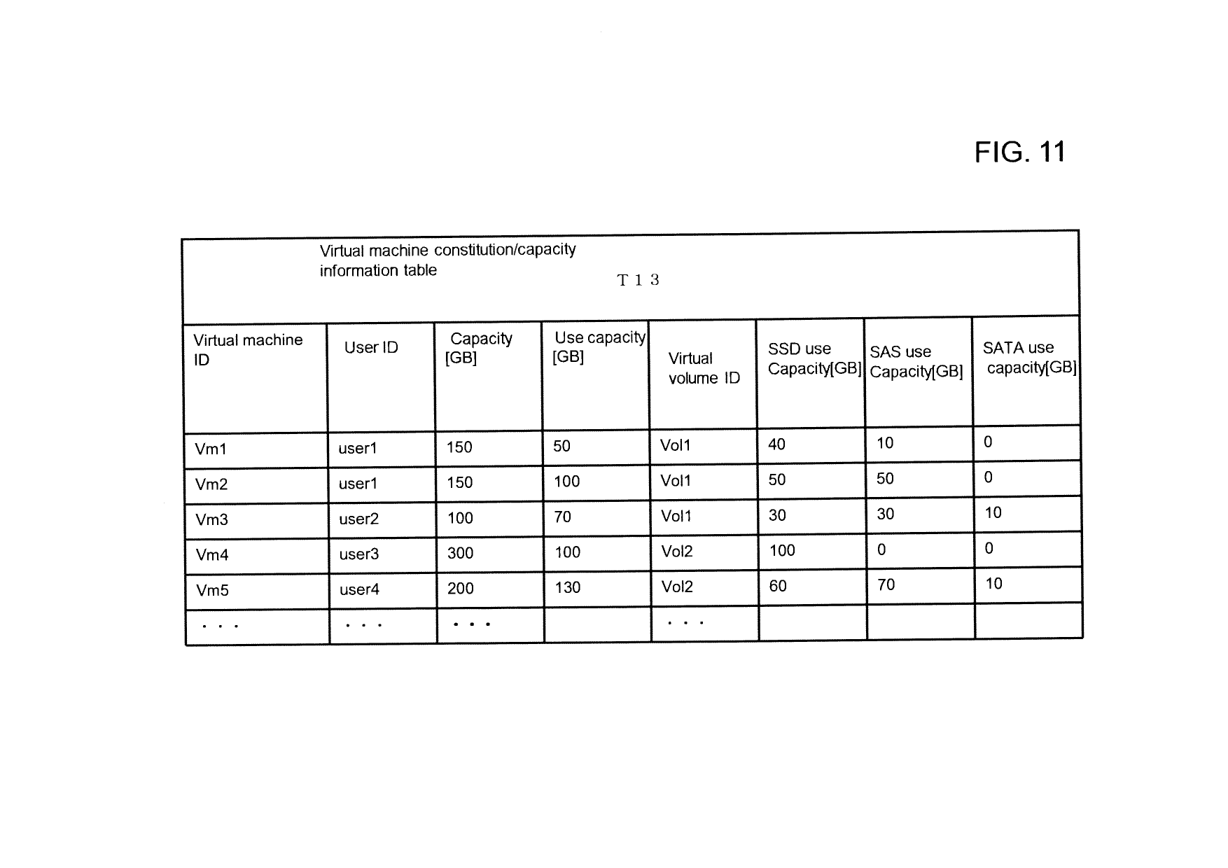

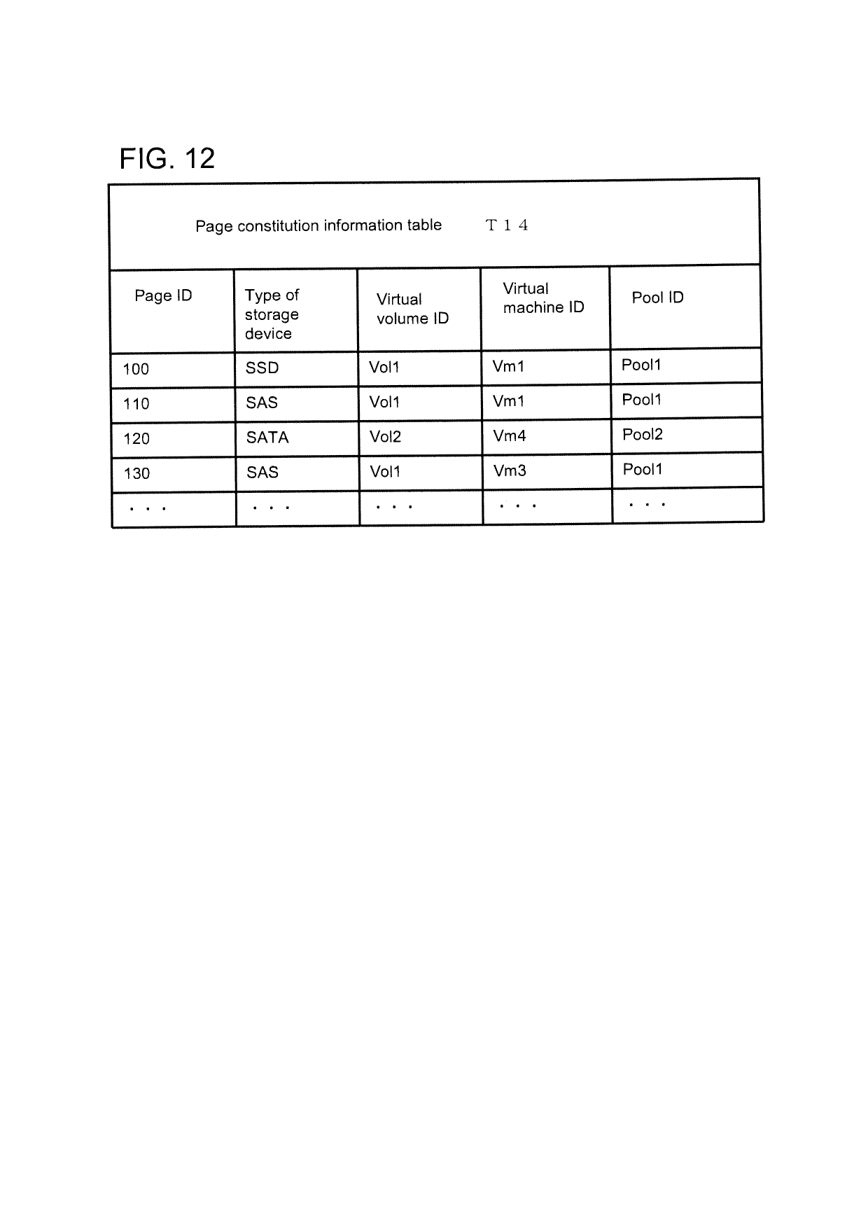

The resource constitution/capacity information 421 is information collected by the agent information collecting part and related to the constitution and capacity of the resource to be registered. The resource constitution/capacity information 421 is constituted by, for example, a pool constitution/capacity information table T10 (FIG. 8), a volume constitution/capacity information table T11 (FIG. 9), a virtual volume constitution/capacity information table T12 (FIG. 10), a virtual machine constitution/capacity information table T13 (FIG. 11), and a page constitution information table T14 (FIG. 12). These tables are described hereinafter.

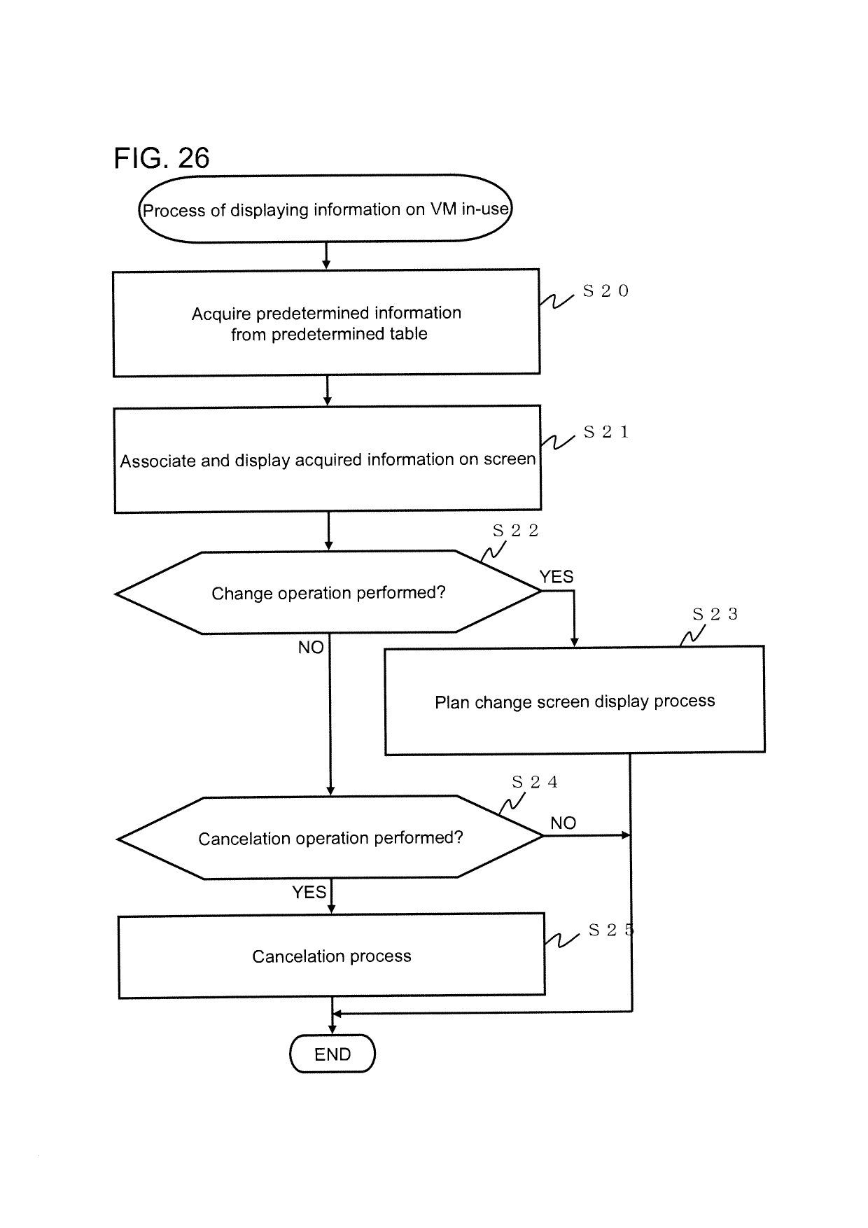

An in-use virtual machine information display part 401 is started from the management client 50 upon instruction from the user. In the diagram, the term “virtual machine” is abbreviated as “VM.” The in-use virtual machine information display part 401 causes the display device of the management client 50 to display information on an in-use virtual machine 100. The in-use virtual machine information display part 401 is often referred to as “virtual machine information display part 401.” Operations of the virtual machine information display part 401 are described hereinafter with reference to FIG. 26.

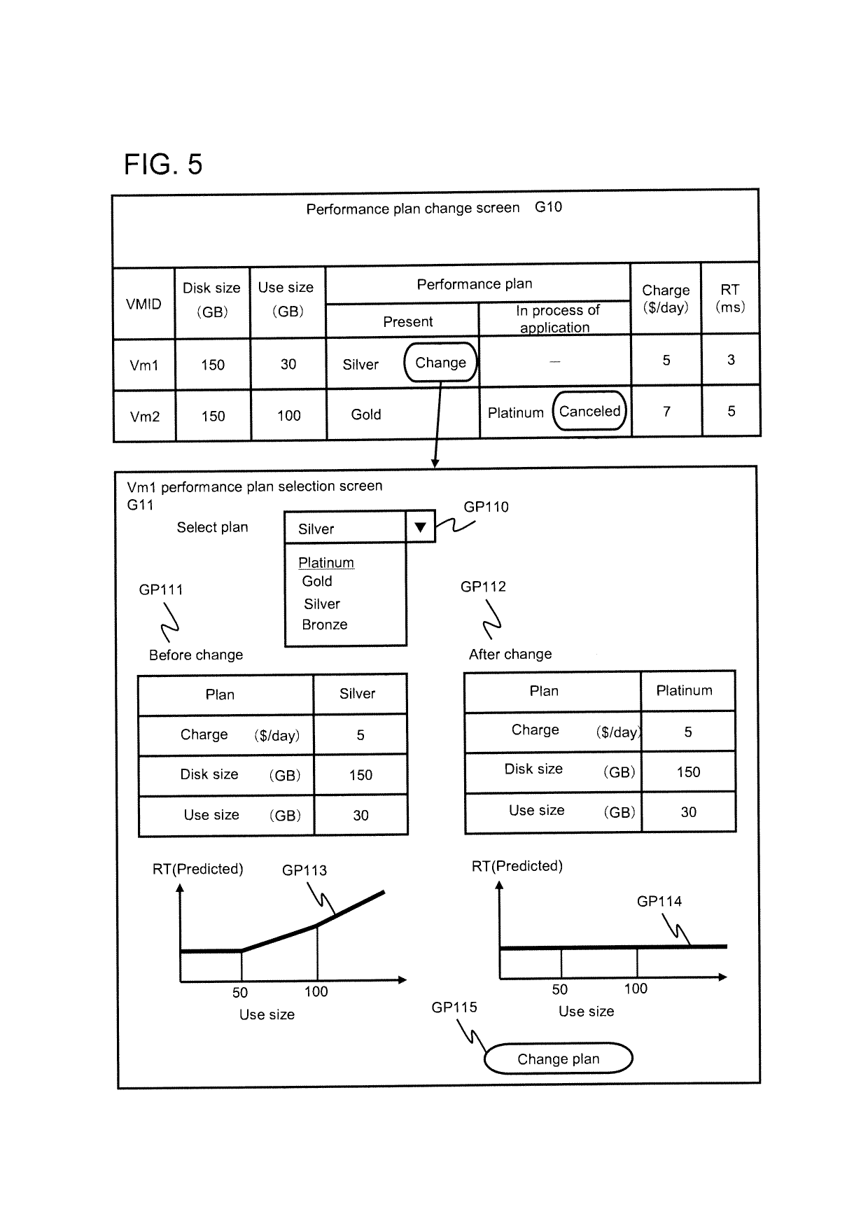

The virtual machine information display part 401 acquires information from the resource performance information 420, the resource constitution/capacity information 421, virtual machine performance plan information 422, and virtual machine performance plan change information 425, and displays the acquired information. Screens G10 and G11 which are displayed by the virtual machine information display part 401 are described hereinafter with reference to FIG. 5.

Once the user presses a change button on the screen G10, a performance plan change screen display part 402 is started, and the screen changes to the screen G11. Once the user presses a cancel button on the screen G10, a performance plan change canceling part 406 is started.

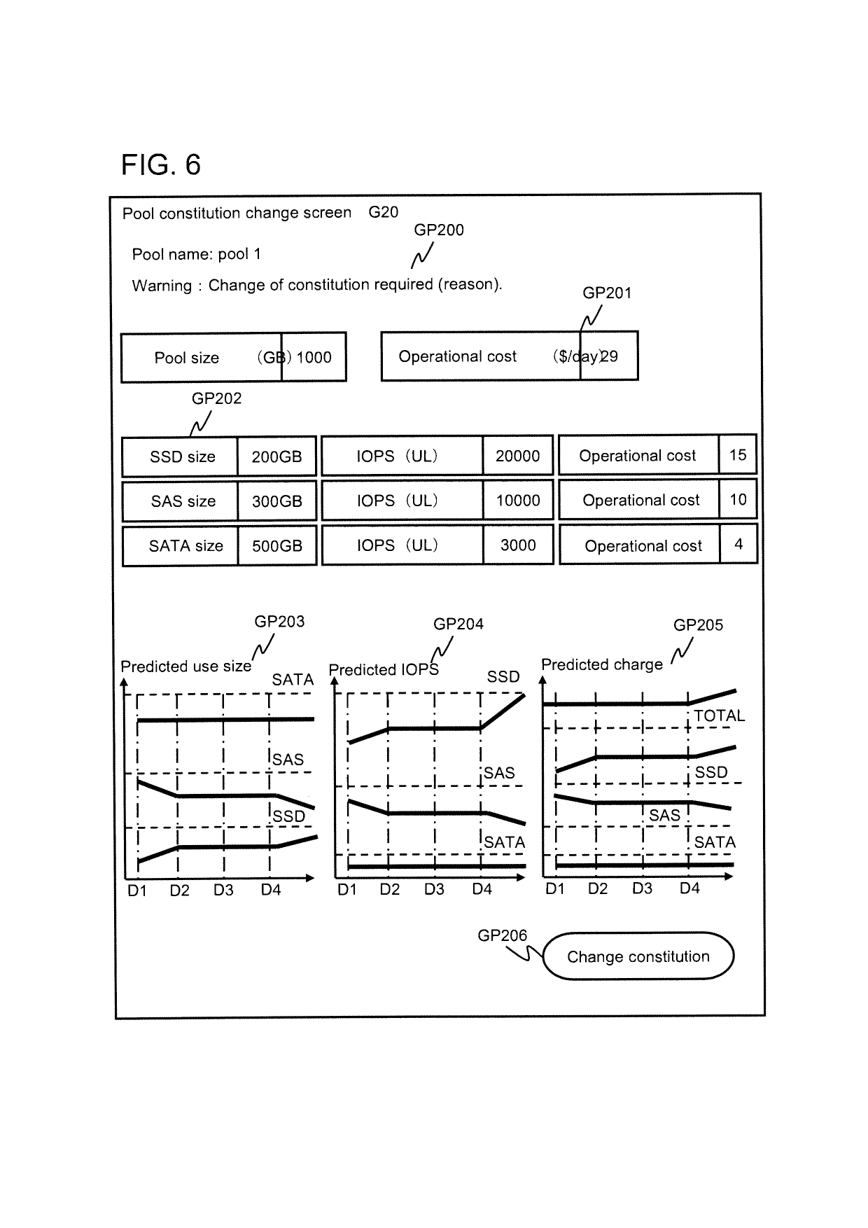

The performance plan change screen display part 402 provides the user with a screen for changing the performance plan. Hereinbelow, the performance plan change screen display part 402 is often abbreviated as “change screen display part 402.” The change screen display part 402 is started from the virtual machine information display part 401 upon instruction from the user. The change screen display part 402 displays the resource constitution/capacity information 421, the virtual machine performance plan information 422, and performance plan information 423 on a screen G20 which is described hereinafter with reference to FIG. 6.

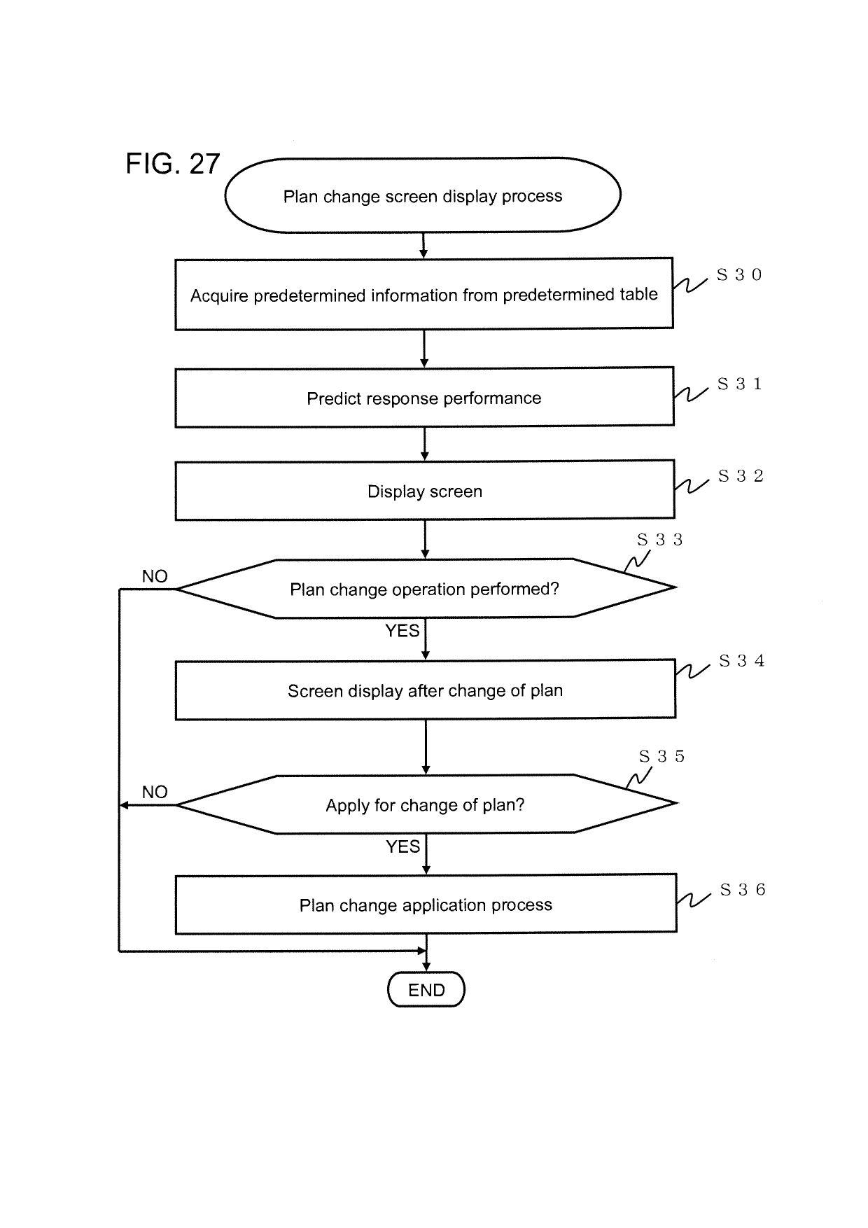

Moreover, the change screen display part 402 starts a predictive response performance calculating part 403 and a post-plan-change fee calculating part 404 upon instruction from the user, and displays information obtained from these calculating parts 403 and 404, on the screen G20. The change screen display part 402 starts a plan change requesting part 405 upon instruction from the user. Operations of the change plan screen part 402 are described with reference to FIG. 27.

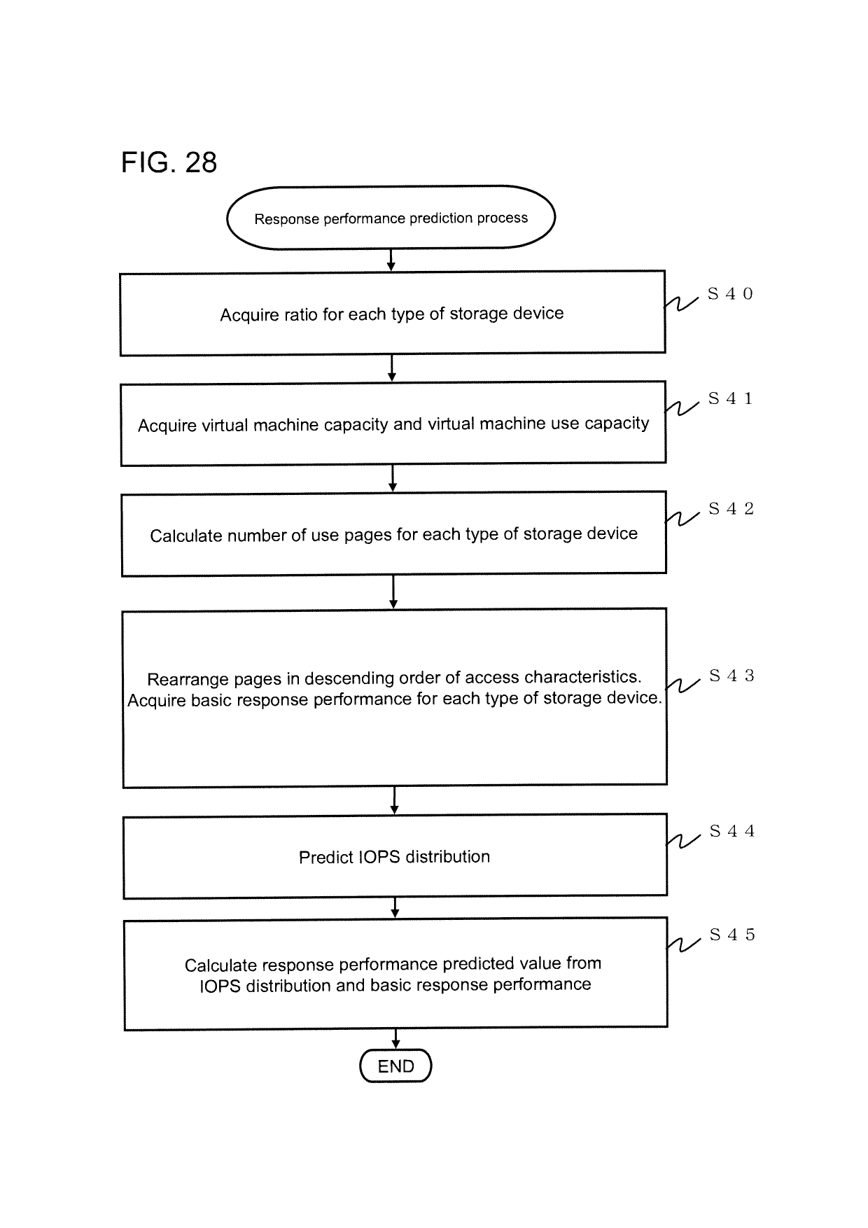

The predictive response performance calculating part 403 calculates a response performance predictive value. The predictive response performance calculating part 403 is started from the display screen display part 402 upon instruction from the user. The predictive response performance calculating part 403 acquires information from the resource performance information 420 and the resource constitution/capacity information 421. Based on the acquired information, the predictive response performance calculating part 403 calculates a change in response performance caused by a change in use capacity of each virtual machine 100, and returns a calculation result (response performance predictive value) to a caller. Procedures carried out by the predictive response performance calculating part 403 are described in detail with reference to FIG. 28.

The post-plan-change fee calculating part 404 calculates a fee after the change of the performance plan. Hereinafter, the post-plan-change fee calculating part 404 is abbreviated as “fee calculating part 404.” The fee calculating part 404 is started from the change screen display part 402 upon instruction from the user.

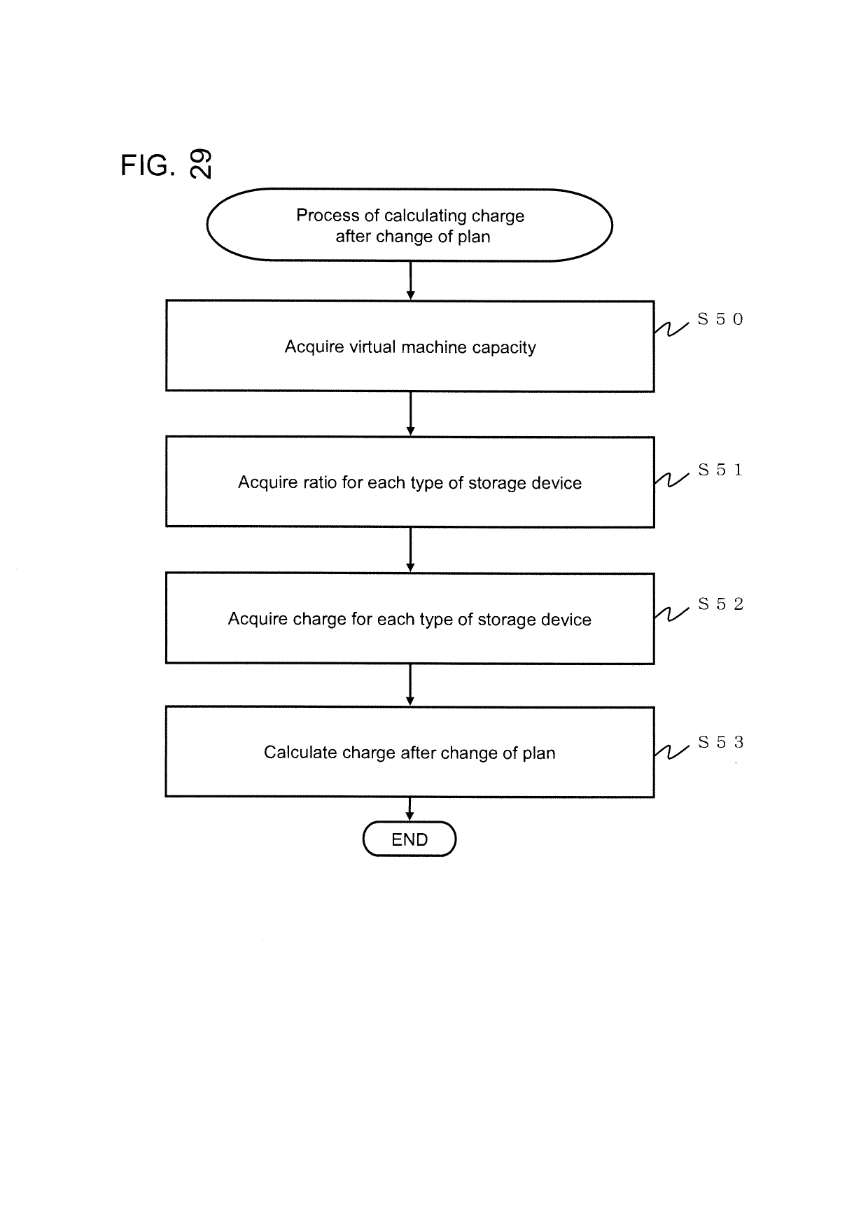

The fee calculating part 404 acquires information from the resource constitution/capacity information 421, the performance plan information 423, and fee information by pool tier 424. Based on the acquired information, the fee calculating part 404 calculates a fee per unit time of the virtual machine 100, and returns a calculation result to the caller. Operations of the fee calculating part 404 are described with reference to FIG. 29.

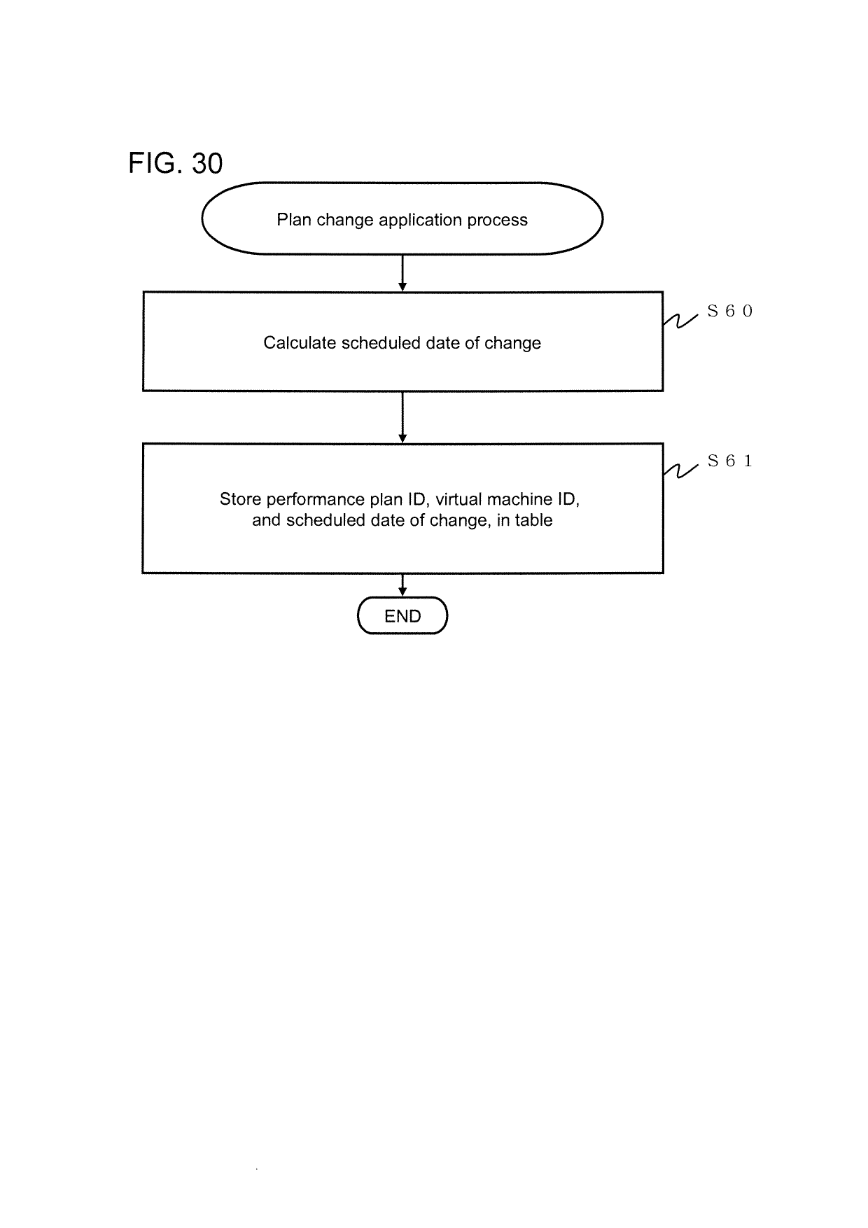

The plan change requesting part 405 requests the management server 40 to change the performance plan. The plan change requesting part 405 is started from the change screen display part 402 upon instruction from the user. The plan change requesting part 405 adds the virtual machine performance plan change information 425 based on an input from the user. Operations of the plan change requesting part 405 are described with reference to FIG. 30.

The performance plan change canceling part 406 cancels the change of the performance plan upon instruction from the user. Hereinafter, the performance plan change canceling part 406 is abbreviated as “change canceling part 406.” The change canceling part 406 is started from the virtual machine information display part 401 upon instruction from the user. The change canceling part 406 deletes the virtual machine performance plan information 422 based on an input from the user. Specifically, when a virtual machine ID is provided as the input, the change canceling part 406 deletes the virtual machine performance plan change information of the input virtual machine ID from a virtual machine performance plan change information table.

A pool information display part 407 displays states of the pools 220. The pool information display part 407 is started from the management client 50 upon instruction from the user. The pool information display part 407 acquires information from the resource performance information 420, the resource constitution/capacity information 421, and storage device operational cost information by pool tier 426. Based on the acquired information, the pool information display part 407 generates pool information to be displayed, and displays the pool information on the screen G20.

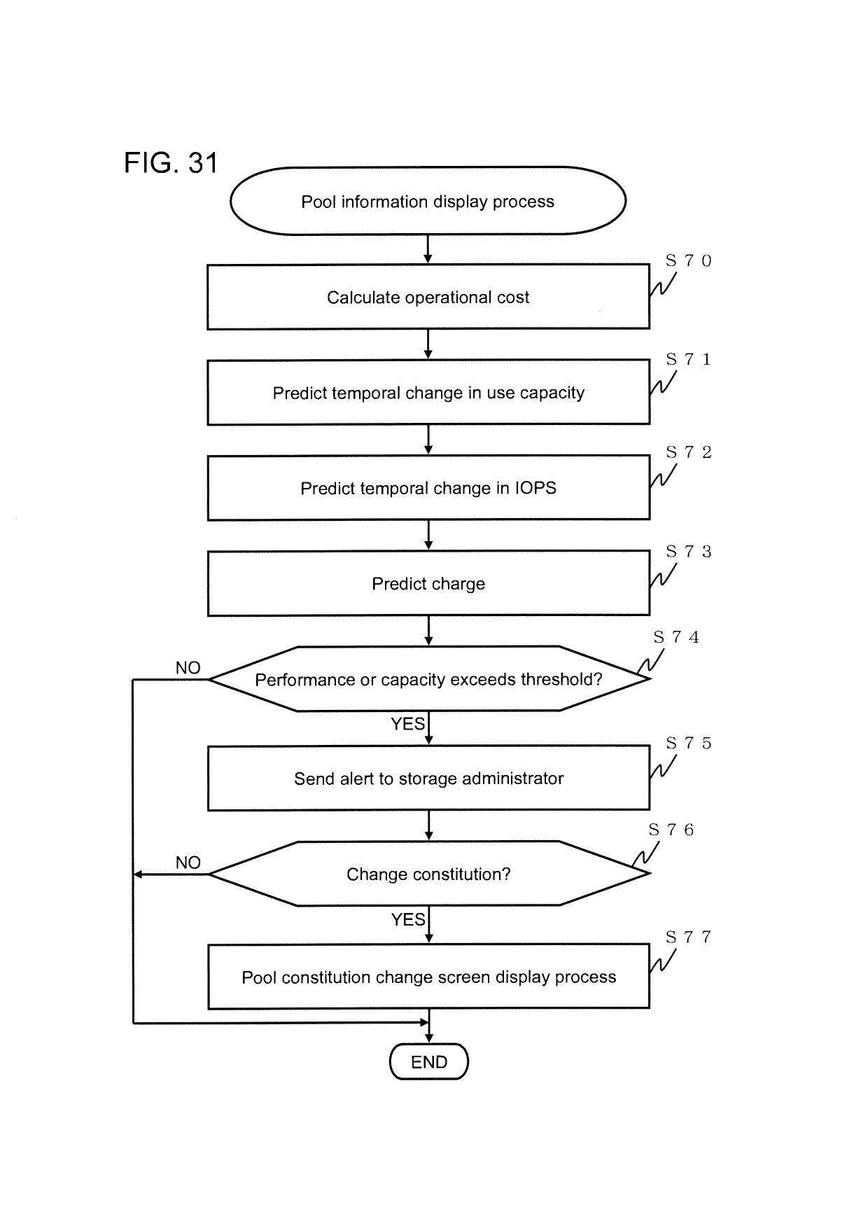

The pool information display part 407 also starts a use capacity predictive value calculating part 408, an IOPS predictive value calculating part 409, and a fee predictive value calculating part 410, and displays on the screen G20 information acquired from these calculating parts. The pool information display part 407 further displays a message on the screen G20 on the basis of the information obtained from the use capacity predictive value calculating part 408 and the IOPS predictive value calculating part 409 and performance/capacity threshold configuration information by pool 427. Operations of the pool information display part 407 are described with reference to FIG. 31.

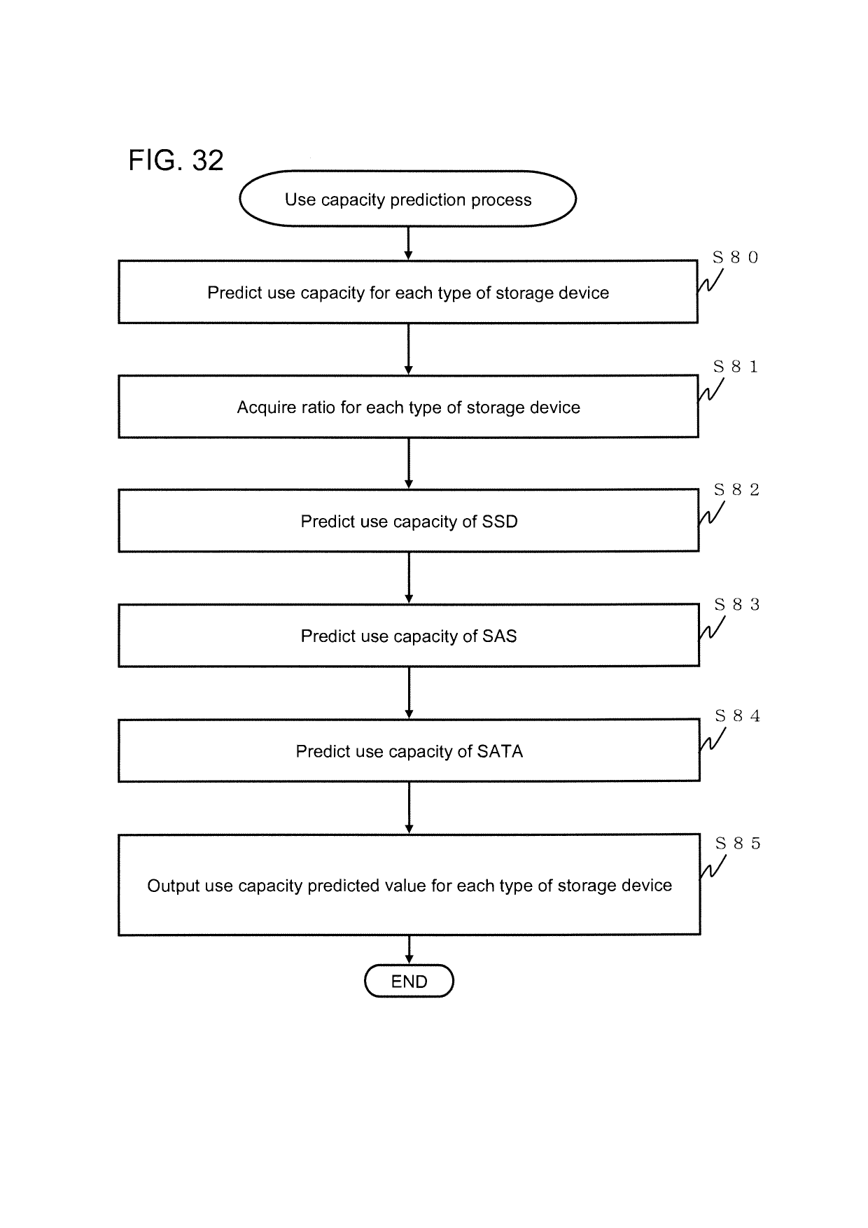

The use capacity predictive value calculating part 408 calculates a use capacity predictive value for each pool 220. The use capacity predictive value calculating part 408 is started from the pool information display part 407 upon instruction from the user. The use capacity predictive value calculating part 408 refers to the resource constitution/capacity information 421, the virtual machine performance plan change information 425, and the performance plan information 423. Based on information acquired from the information 421, 425, and 423, the use capacity predictive value calculating part 408 calculates the use capacity predictive value of each type of storage device corresponding to the pool 220 based on a change in time/date, and returns a calculation result to the caller. The use capacity predictive value calculating part 408 is described in detail with reference to FIG. 32.

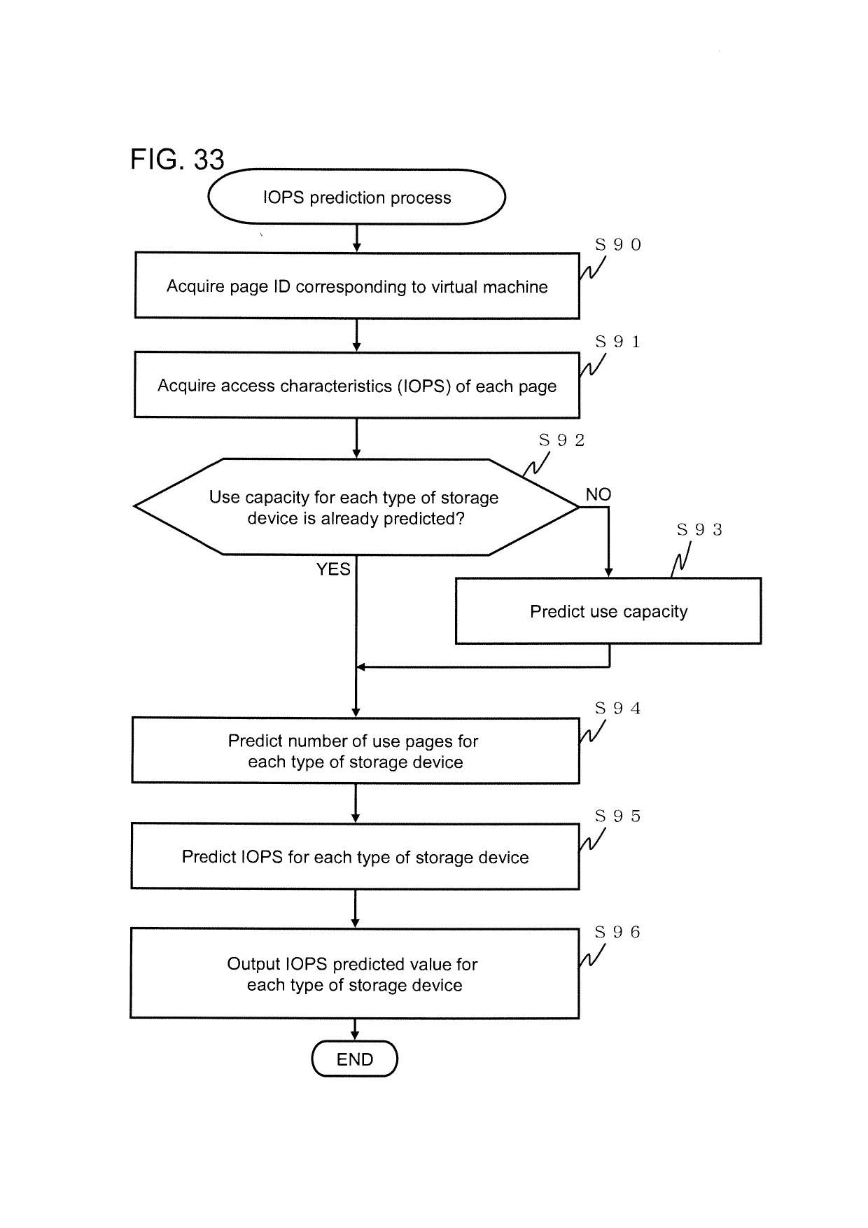

The IOPS predictive value calculating part 409 calculates an IOPS predictive value. The IOPS predictive value calculating part 409 is started from the pool information display part 407 upon instruction from the user. The IOPS predictive value calculating part 409 refers to the resource performance information 420, the resource constitution/capacity information 421, the virtual machine performance plan change information 425, and the performance plan information 423. Based on the information acquired from the information 420, 421, 425, and 423, the IOPS predictive value calculating part 409 calculates the IOPS predictive value of each type of storage device corresponding to the pool 220 based on a change in time and date, and returns a calculation result to the caller. Operations of the IOPS predictive value calculating part 409 are described with reference to FIG. 33.

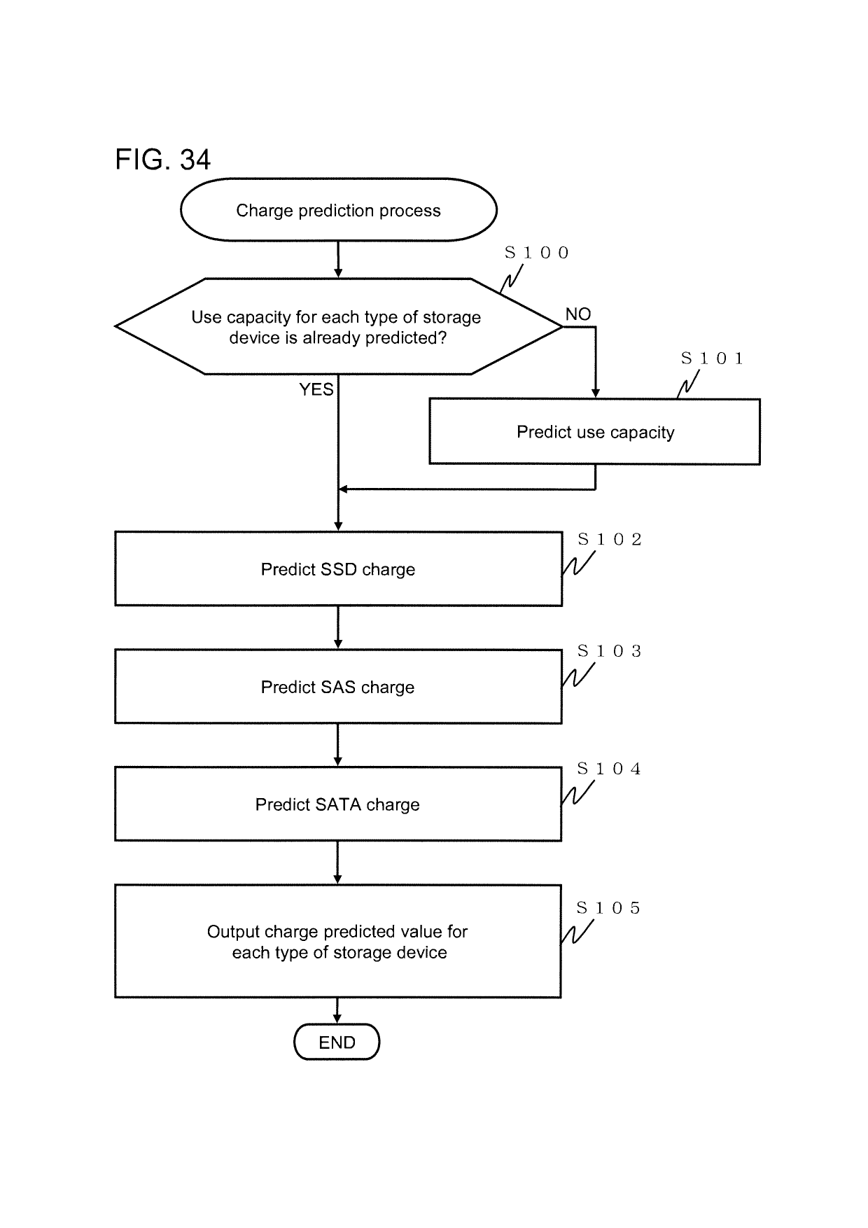

The fee predictive value calculating part 410 calculates a fee predictive value. The fee predictive value calculating part 410 is started from the pool information display part 407 upon instruction from the user. The fee predictive value calculating part 410 refers to the resource constitution/capacity information 421, the virtual machine performance plan change information 425, and the performance plan information 423. Based on the information acquired from the information 421, 425, and 423, the fee predictive value calculating part 410 calculates the fee predictive value based on a change in time/date. The predictive value to be calculated includes a fee per unit time of each type of storage device corresponding to the pool 220 and a fee predictive value per unit time of the pool 220. The fee predictive value calculating part 410 returns a calculation result to the caller. Operations of the fee predictive value calculating part 410 are described with reference to FIG. 34.

A page arrangement computing part 411 calculates the page arrangement destination. The page arrangement destination is a storage tier for storing data of the virtual volumes 210. The page arrangement computing part 411 is executed on a regular or irregular basis. When the page arrangement computing part 411 is executed on a regular basis, the page arrangement computing part 411 is executed at a predetermined time according to the programmed schedule or time. When the page arrangement computing part 411 is executed on an irregular basis, the page arrangement computing part 411 is executed upon instruction from the user.

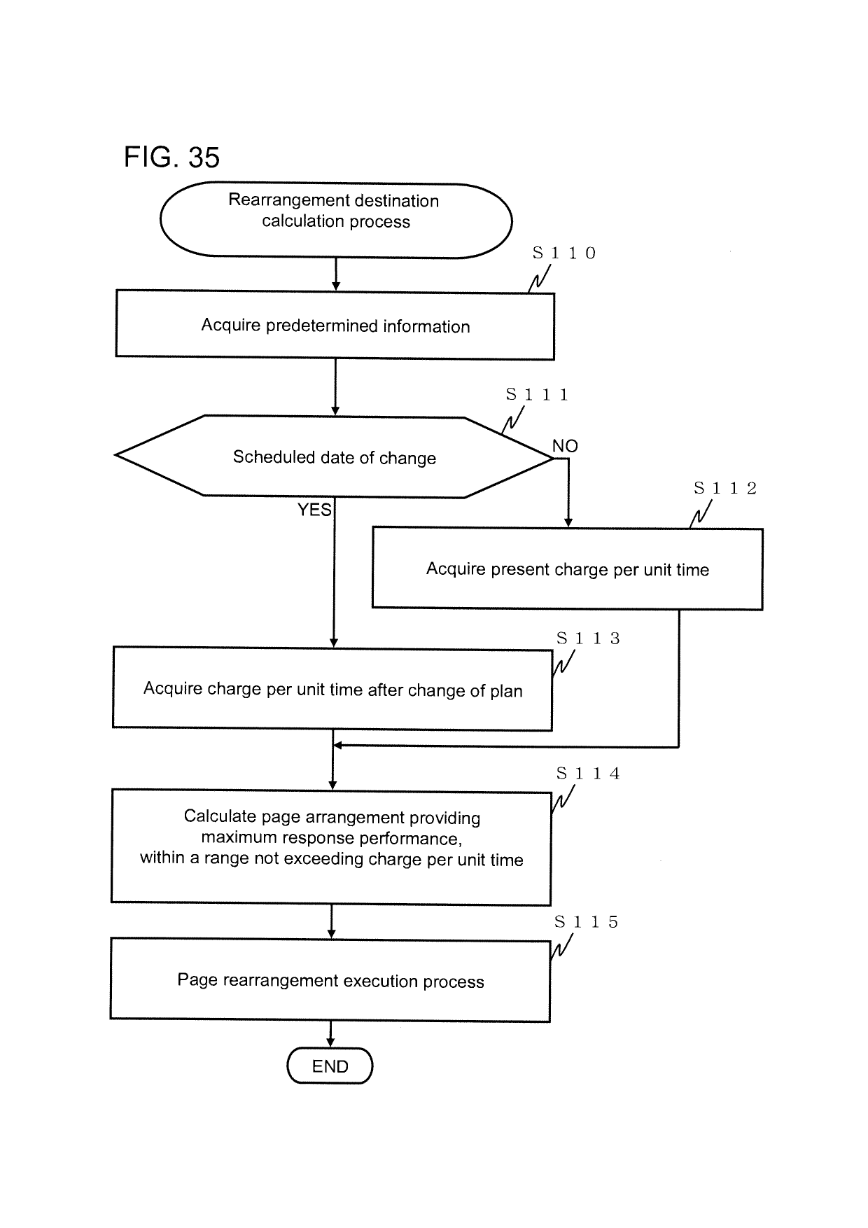

The page arrangement computing part 411 refers to the resource performance information 420, the resource constitution/capacity information 421, the virtual machine performance plan information 422, the performance plan information 423, and the virtual machine performance plan change information 425. Based on the information 420 to 423 and 425, the page arrangement computing part 411 calculates a page rearrangement destination and stores a calculation result in page rearrangement information 428. The page rearrangement destination (also referred to as “page arrangement destination”) is information indicating the pages that are stored in each type of storage device after the pages are rearranged. After calculating the page rearrangement destination, the page arrangement computing part 411 starts a page rearrangement execution part 412. Operations of the page arrangement computing part 411 are described with reference to FIG. 35.

The page rearrangement execution part 412 rearranges the pages in the tiers. The page rearrangement execution part 412 is started after the page rearrangement destination is calculated by the page arrangement calculating part 411. Based on the page rearrangement information 428, the page rearrangement execution part 412 instructs the pool controller 201 to rearrange the pages.

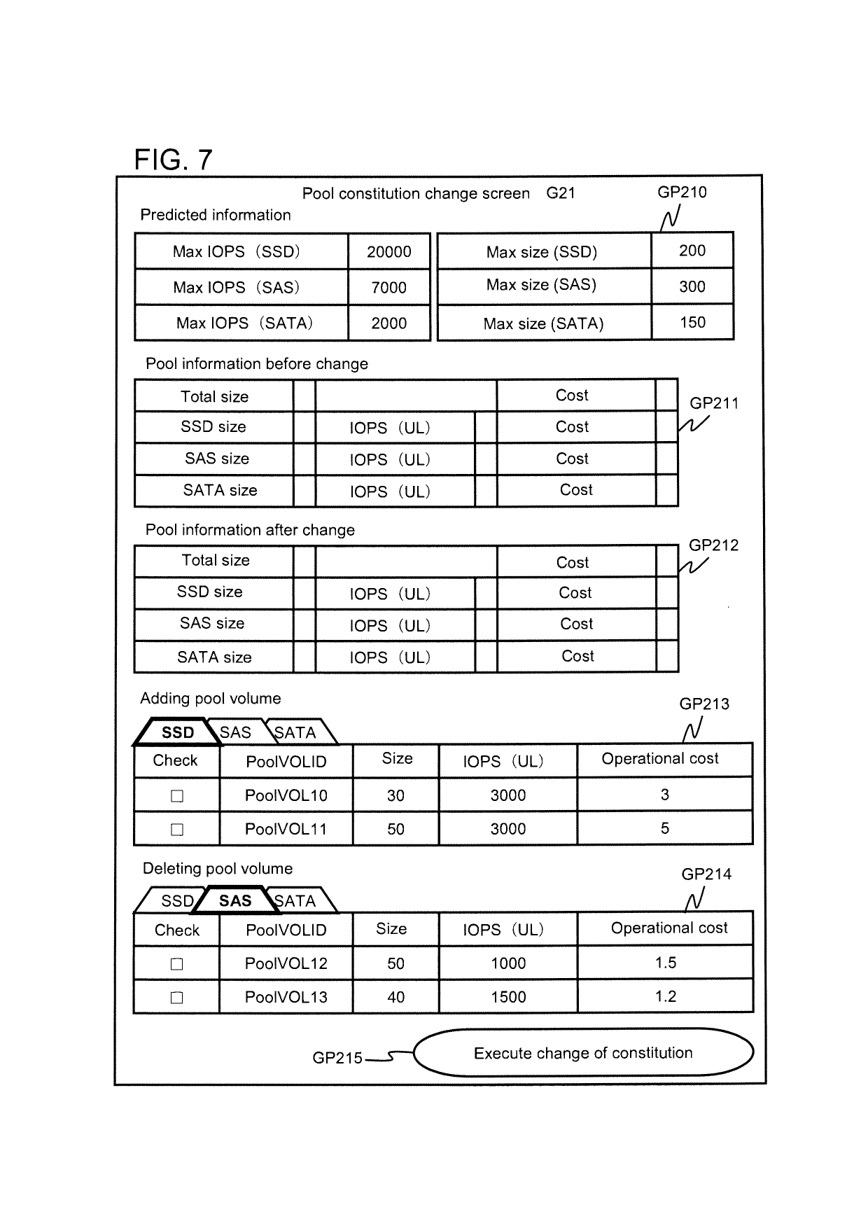

A pool constitution change screen display part 413 displays a screen G21 for changing the constitution of the pool 220 (FIG. 7). The pool constitution change screen display part 413 is started from the pool information display part 407 upon instruction from the user.

The pool constitution change screen display part 413 acquires information from the resource constitution/capacity information 421, the resource performance information 420, the storage device operational cost information by pool tier 426, and the performance/capacity threshold configuration information by pool 427. The pool constitution change screen display part 413 generates display information based on the acquired information, and displays the display information on the screen G21.

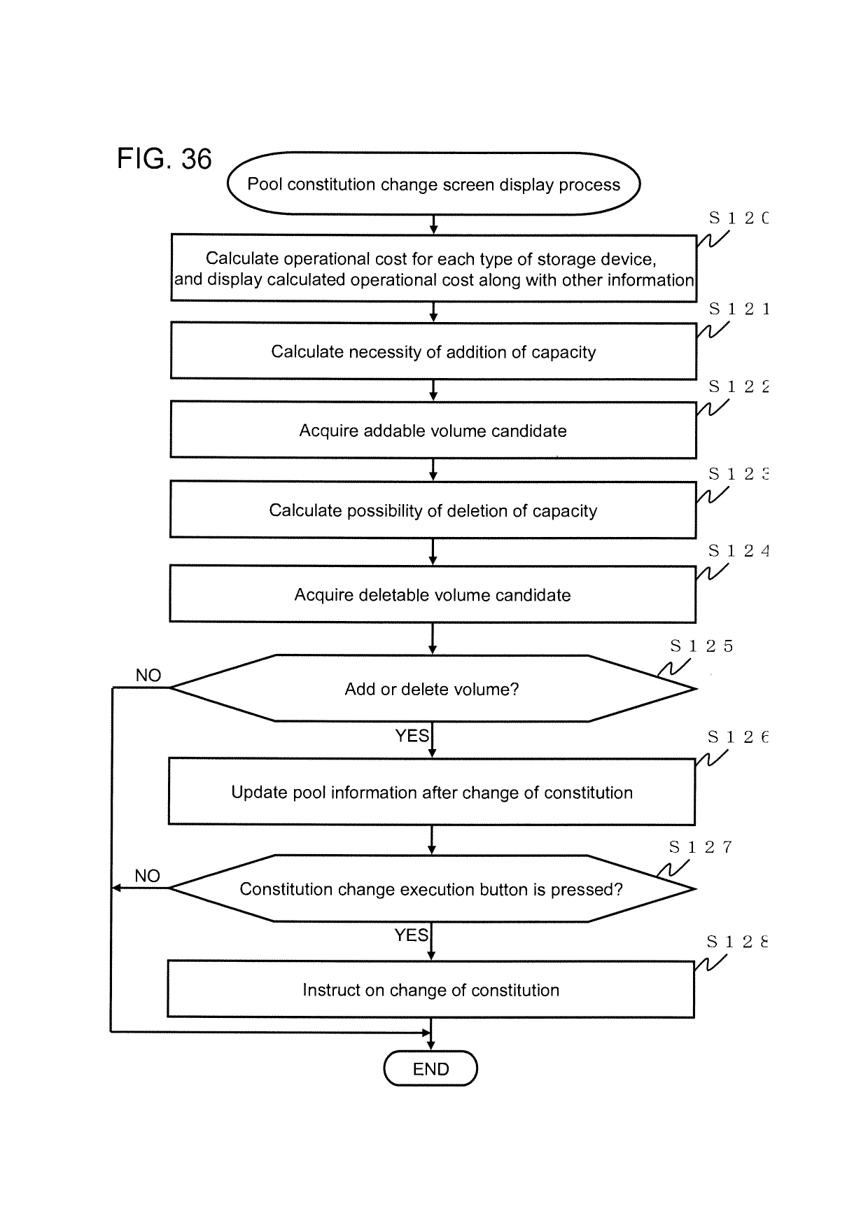

In response to an instruction from the user, the pool constitution change screen display part 413 also instructs the pool controller 201 to change the constitution of the pool 220. Operations of the pool constitution change screen display part 413 are described with reference to FIG. 36.

FIG. 4 is a schematic diagram showing a relationship among the virtual volumes 210, pool 220, pool volumes 232, storage devices 230, and the like.

FIG. 4 shows only one storage apparatus 20, but there may be a plurality of storage apparatuses. Furthermore, the management server 40 may be connected to the storage apparatus 20 by the SAN switch 60. The management software 400 may be provided in the storage apparatus 20.

The virtualization server 10 is any one of the virtualization servers 10 shown in FIG. 2. The SAN switch 60 is any one of the SAN switches 60 shown in FIG. 2. The storage apparatus 20 is any one of the storage apparatuses 20 shown in FIG. 2.

In the virtualization server 10, a plurality of (or one) virtual machines 100 are run on the data store 11 functioning as a disk region of the virtualization server 10. Application programs and the like are run on the virtual machines 100. The virtual machines 100 store operating systems and application programs thereof in a virtual disk created on the data store 11. The virtual volumes 210 of the storage apparatus 20 are allocated to the data store 11 of the virtualization server 10.

Although not shown in FIG. 4, the storage monitoring agent (often abbreviated as “monitoring agent”) 300 is run in order to acquire the information on the constitution and performance of the storage apparatus 20 (see FIG. 2).

The monitoring agent 300 acquires information from, for example, the virtual volumes 210, storage ports 22, pool 220, storage tiers 221A to 221C, page (PA, PB, and PC) parity groups 231A to 231C, pool volumes 232A to 232C, pages, virtual machines 100, and virtual disk.

Unless otherwise distinguished, the storage tiers 221A to 221C are abbreviated as “storage tiers 221,” the parity groups 231A to 231C as “parity groups 231,” the pool volumes 232A to 232C as “pool volumes 232,” and the storage devices 230A to 230C as “storage devices 230.”

Each of the parity groups 231A to 231C is a logical disk drive that is generated from the plurality of types of storage devices 230A to 230C by a function of the controller of the storage apparatus 20.

In the present example, for instance, each storage device 230A is constituted as a SSD, each storage device 230B as a SAS, and each storage device 230C as a SATA. Storage devices other than the SSD, SAS and SATA may be used. The number of types of the storage devices is not limited to three; thus, two types or four or more types of storage devices may be used.

The pool volumes 232A to 232C are logical disk drives (actual logical volumes) that are created by separating the parity groups 231A to 231C by means of the function of the controller of the storage apparatus 20. Storage regions corresponding to defined capacities obtained upon the creation of the pool volumes 232A to 232C are secured beforehand on the parity groups 231A to 231C.

The storage tiers 221A to 221C are tiers of the logical storage devices that are created for each type of the storage devices 230A to 230C. The storage tiers 221A to 221C are constituted from the pool volumes 232A to 232C that are created based on the storage devices 230A to 230C.

For example, a storage tier 221A “Tier 1,” which is a high tier, is constituted from the pool volume 232A generated based on the high-performance storage device 230A. A storage tier 221B “Tier 2,” which is a middle tier, is constituted from the pool volume 232B generated based on the medium-performance storage device 230B. The storage tier 221C, a low tier, is constituted from the pool volume 232C generated based on the lower-performance storage device 230C.

Therefore, the storage tier 221A has the pages of higher performance than the storage tier 221B, and the storage tier 221B has pages of higher performance than the storage tier 221C. The pages are the unit of storage regions for storing data. The pages are described hereinafter.

The pool 220 allocates the storage regions (pages) to the virtual volumes 210. The pool 220 is constituted from the abovementioned storage tiers 221A to 221C.

As with the pool volumes 232A to 232C, the virtual volumes 210 are created and controlled by the virtual volume controller 00 of the storage apparatus 20. The virtual volumes 210 are recognized by the virtualization server 10 as logical disk drives.

However, unlike the pool volumes 232, which are the actual logical volumes, the capacities of the virtual volumes 210 are defined upon the creation thereof, but the storage regions corresponding to the defined capacities are not actually ensured.

When the virtual machine 100 issues a write request to a new address of any of the virtual volumes 210, the storage regions of the pool 220 are allocated to the new address. The storage regions are allocated to the virtual volume 210 in units of pages as described hereinafter.

As shown in FIG. 4, three pages of “PA1” to “PA3” and five pages “PB1” to “PB5” are allocated from the storage tier 221A “Tier 1” and the storage tier 221B “Tire 2” respectively, to a virtual volume 210 “VVol 1.”

Two pages of “PA4” to “PA5,” four pages of “PB6” to “PB9,” and one page of “PC1” are allocated from the storage tier 221A “Tier 1,” the storage tier 221B “Tier 2,” and a storage tier 221C “Tier 3,” respectively, to a virtual volume 210 “VVol 2.” The mechanism for allocating the pages is described hereinafter.

The pages “PA1” to “PC9” are the storage regions allocated to the virtual volumes 210. For the virtual volumes 210 that belong to the pool 220 having the plurality of types of storage tiers 221, the pages are arranged in the high-performance storage tiers, in descending order of access characteristics. Examples of the access characteristics used as the parameter for arranging the pages include the number of I/Os (IOPS) per unit time and a latest access time.

The pages of relatively low access characteristics are arranged in the low-performance storage tiers. The page arrangement destinations are determined by the management software 400. The management software 400 acquires the constitution information (storage tier information, page information) of the storage apparatus 20 and information on access characteristics per page, from the storage apparatus 20. The management software 400 determines the page arrangement destinations according to the rules described above.

An example is described. Suppose that the access characteristics with respect to the page “PB3” used currently by the virtual volume 210 “VVol 1” rise significantly. In this case, the management software 400 allocates the page “PA4” of the high tier 221A “Tier 1” to the virtual volume 210 “VVol 1” and the page “PB3” of the middle tier 221B “Tier 2” to the other virtual volume 210 “VVol 2.”

In this manner, the pool 220 provides the virtual volumes 210 to the virtualization server 10. The pool volumes 232A to 232C are generated based on the storage devices 230A to 230C of different performances and associated with the corresponding tiers out of the storage tiers 221A to 221C of the pool 220.

FIG. 5 shows examples of the screens provided to the user by the management software 400. The user is a user of any of the virtual machines 100 and different from the storage administrator. FIG. 5 shows the performance plan change screen G10 for changing the performance plan and the screen G11 for selecting the performance plan to be changed.

The management software 400 displays, on the screens, information acquired from the virtual machine constitution/capacity information table T13, the virtual machine performance information table T16, a virtual machine performance plan information table T22, and a virtual machine performance plan change information table T25.

A constitution of the performance plan change screen G10 shown on the upper side of FIG. 5 is now described. The screen G10 includes, for example, a region for displaying the ID of each virtual machine 100, a region for displaying a disk capacity, a region for displaying a disk use capacity, a region for displaying a performance plan, a region for displaying a fee, a region for displaying a response performance, and a plurality of buttons.

The disk capacity is a total capacity that can be used by each virtual machine 100. The use capacity is a capacity that is actually used by each virtual machine 100. The performance plan display region includes a region for displaying a current performance plan and a region for displaying a performance plan that is in the process of change request. Further, the region for displaying the current performance plan is provided with a change button for requesting change of the performance plan. The region for displaying a performance plan that is in the process of change request is provided with a cancel button for canceling the request.

The region for displaying fees displays a fee per unit time with respect to the current performance plan. The region for displaying a response performance displays a response speed (abbreviated as “RT” in the diagram) as the response performance.

For example, when the user wishes to confirm or change the performance plan applied to the virtual machine 100, the user confirms the screen G10. For instance, the user can use a user terminal, not shown, or the virtualization server 10 to log into the management server 40 and to see the screen G10.

The user who wishes to change the performance plan presses the change button. Once the user presses the change button, the screen changes to the selection screen G11 shown on the lower side of FIG. 5.

The management software 400 acquires information from the resource constitution/capacity information 421, the resource performance information 420, the virtual machine performance plan information 422, the virtual machine performance plan change information 425, the performance plan information 423, and the fee information by pool tier 424. The management software 400 then generates the screen G11 based on the acquired information, and presents the screen G11 to the user of the virtual machine 100.

The selection screen G11 includes a region GP110 for selecting the performance plan, a region GP111 for displaying information on the performance plan before the change, a region GP112 for displaying information on the performance plan after the change, charts GP113 and GP114 showing changes in the response performance before and after the change of the performance plan, and a plan change button GP115.

The performance plan selection region GP110 has, for example, a pull-down menu. The user can select any one of the performance plans displayed in the pull-down menu.

The region GP111 for displaying information on the performance plan before the change displays, for example, a plan ID for specifying the current performance plan, a fee per unit time, a maximum disk capacity that can be used, and a disk capacity that is actually used. The region GP112 for displaying information on the performance plan after the change displays the plan ID for specifying the performance plan that the user wishes to change, the fee per unit time, the maximum disk capacity that can be used, and the disk capacity that is actually used.

The chart GP113 showing the current response performance is a graph of the predictive values showing a relationship between the use capacity and the response time in the current performance plan. The chart GP114 showing the response performance after the change of the performance plan is a graph of the predictive values showing a relationship between the use capacity and the response time in the current performance plan.

The region GP112 for displaying the information on the performance plan after the change and the chart GP114 showing a change in the response performance after the change of the performance plan are displayed on the screen G11, only when another performance plan different from the current performance plan is selected in the performance plan selection region GP111.

The chart GP113 is now described briefly. The performance plan “silver” (often referred to as “silver plan” hereinafter) has less available amount of the high-performance tier 221A and more available amount of the medium-performance and low-performance tiers 221B and 221C. Therefore, when the virtual machine 100 to which the silver plan is applied has less use capacity, the response time of the virtual volumes can be made relatively short (i.e., the response performance thereof can be increased). However, when the use capacity of the virtual machine 100 exceeds an upper limit of the available amount of the high-performance tier 221A, the pages of the medium-performance storage tier 221B are allocated to the virtual machine 100. As a result, an average response time of the virtual volumes with respect to an access request from the virtual machine 100 increases. Moreover, when the use capacity of the virtual machine exceeds an upper limit of the available amount of the medium-performance storage tier 221B, the pages of the low-performance storage tier 221C are allocated to the virtual machine 100, further increasing the average response time. In other words, in the case of the silver plan, the response performances of the virtual volumes 210 becomes lower as the disk capacity used by the virtual machine 100 becomes larger.

The chart GP114 is now described. The performance plan “platinum” (often referred to as “platinum plan” hereinafter) uses, for example, only the high-performance storage tier 221A. Therefore, in the case of the virtual machine 100 to which the platinum plan is applied, the average response time of the virtual volumes 210 is substantially constant even when the use capacities thereof are increased.

As described above, on the screen G10 the user can confirm the current performance plan and a performance plan that is in the process of change request. In addition, the user can request for a change of the performance plan or cancel the request by operating the change button or cancel button on the screen G10.

On the screen G11 the user can confirm the situation of the current performance plan and the situation obtained after changing the performance plan by comparing them. The user presses the plan change button GP115 after confirming a comparison result. Once the plan change button GP115 is pressed, a preparation for changing the performance plan is begun, as described hereinbelow.

FIG. 6 shows an example of the screen G20 for changing the constitution of the pool 220. This screen G20 is provided to the administrator.

The management software 400 acquires information from the resource performance information 420, the resource constitution/capacity information 421, the storage device operational cost information by pool tier 426, the performance/capacity threshold configuration information by pool 427, the performance plan information 423, the virtual machine performance plan change information 425, and the fee information by pool tier 424. The management software 400 generates the screen G20 based on the acquired information and provides the screen G20 to the administrator.

The pool constitution change screen G20 has, for example, a region GP200 for displaying a pool ID and a message, a region GP201 for displaying a total capacity and operational cost of the pool, a region GP202 for displaying a capacity, IOPS, and operational cost by type of storage device, and prediction display regions GP203 to GP205.

The display region GP200 displays a pool ID for specifying the pool, the constitution of which is to be changed, and a message about this target pool. Examples of the message include “usage of higher-performance tier (SSD) is approaching its upper limit. Please add capacity,” “IOPS of medium-performance tier (SAS) has reached its lower limit. Please reduce capacity,” “sales of the entire pool are below operational cost.”

The display region GP201 displays the total capacity of the target pool and the operational cost per unit time of the entire target pool. In the present example, a time period of 1 day is described as an example of the unit time; however, the unit time is not limited thereto and may be configured as other values, such as 12 hours or 48 hours.

The display region GP202 displays, by type of the storage device 230, the capacity, IOPS, and operational cost included in the target pool 220. In other words, the display region GP202 displays the capacity, IOPS, and operational cost for each of the storage tiers 221 of the target pool 220.

The prediction display region GP203 displays graphs of predictive values showing how the use capacity of each type of storage device 230 (each storage tier) changes over time. The prediction display region GP204 displays graphs of predictive values showing how the IOPS of each type of storage device 230 (each storage tier) changes over time. The prediction display region GP205 displays graphs of predictive values showing how the fee and operational cost of each type of storage device 230 (each storage tier) change over time.

In the prediction display region GP205, dotted horizontal lines show the operational costs. Thick solid lines show the fees. The SATA shown by the bottom line is now described. The fee (also referred to as “revenue” or “sales”) per unit time of the solid-line SATA is below the operational cost of the dotted-line SATA per unit time. It is, therefore, clear that predictive revenue and expenditure of the storage tier 221C constituted from the SATA are in deficit.

Focusing on a total fee, the thick solid line represents the sum of fees of the entire pool per unit time (sales of the entire pool per unit time). The dotted line represents the operational cost per unit time of the entire pool. Thus, it is clear that total predictive revenue and expenditure of the target pool 220 are in surplus.

The administrator can determine the current state of the target pool and the need for changing the constitution of the same, by confirming the screen G20. When wishing to change the constitution of the target pool, the administrator presses a constitution change button GP206 of the screen G20. Once the administrator presses the constitution change button GP206, the screen changes to the detailed screen G21 shown in FIG. 7.

FIG. 7 is the screen G21 showing detailed information on the change in the constitution. The screen G21 has, for example, a region GP210 for displaying predictive information, a region GP211 for displaying pool information before the change, and a region GP212 for displaying pool information after the change. The screen G21 further has a region GP213 for instructing to add the pool volumes, a region GP214 for instructing to delete the pool volumes, and a button GP215 for instructing to execute the change of the constitution.

The region GP210 for displaying predictive information on the pool displays, for example, a maximum IOPS predictive value and a maximum use capacity predictive value for each type of storage device.

The region GP211 for displaying information on the pool before the change of the constitution thereof displays, for example, the capacity of the entire pool, the capacity of each type of storage device, allowable IOPS for each type of storage device, and the operational cost per unit time of each type of storage device. The allowable IOPS is a value of an allowable IOPS, which is an upper value of the IOPS.

As with the region GP211, the region GP212 for displaying information on the pool after the change of the constitution thereof displays the capacity of the entire pool, the capacity of each type of storage device, the allowable IOPS for each type of storage device, and the operational cost of each type of storage device.

The region GP213 for instructing to add the pool volumes 232 has a tab for each type of storage device to allow the pool volumes to be added for each type of storage device. The region GP213 displays, for example, a check column for selecting the pool volumes to be added, the IDs of the pool volumes, the capacities of the pool volumes, the allowable IOPS of the pool volumes, and the operational costs per unit time of the pool volumes.

The management software 400 extracts candidates for the pool volumes 232 that can be added to the target pool 220, for each type of storage device, and displays the candidates in the region GP 213. The administrator selects one or a plurality of pool volumes from these candidates.

The region GP214 for deleting the pool volumes 232 from the pool 220 has a tab for each type of storage device to allow the pool volumes 232 to be deleted for each type of storage device. As with the region GP213, the region GP214 displays, for example, a check column for selecting the pool volumes to be deleted, the IDs of the pool volumes, the capacities of the pool volumes, the allowable IOPS of the pool volumes, and the operational costs per unit time of the pool volumes.

The management software 400 extracts candidates for the pool volumes 232 that can be deleted from the target pool 220, for each type of storage device, and displays the candidates in the region GP 214. The administrator selects one or a plurality of pool volumes from these candidates.

Examples of the constitutions of management information are described with reference to FIGS. 8 to 24.

FIG. 8 is an explanatory diagram showing an example of a structure of the pool constitution/capacity information table T10 included in the resource constitution/capacity information 421. The table T10 manages the constitutions and capacities of the pools 220. For each pool, the storage monitoring agent 300 collects the pool ID, the capacity, the use capacity, and the capacity and use capacity of each type of storage device (SSD capacity, SSD use capacity, SAS capacity, SAS use capacity, SATA capacity, and SATA use capacity). The agent information collecting part (FIG. 25) acquires these collected values from the storage monitoring agent 300 and stores the acquired values in the table T10.

FIG. 9 is an explanatory diagram showing an example of a structure of the volume constitution/capacity information table T11 included in the resource constitution/capacity information 421. The table T11 manages the constitutions and capacities of the pool volumes 232. For each volume, the storage monitoring agent 300 collects the volume ID, each type of storage device (each storage device is often referred to as “disk” in the diagram), the capacity, and the pool ID. The agent information collecting part acquires these collected values from the storage monitoring agent 300 and stores the acquired values in the table T11. Note that values effective for the pool IDs are stored only for the pool volumes 232 forming each pool 220. The pool volumes 232 that are not registered in the pools 220 do not have effective pool IDs.

FIG. 10 is an explanatory diagram showing an example of a structure of the virtual volume constitution/capacity information table T12 included in the resource constitution/capacity information 421. The table T12 manages the constitutions and capacities of the virtual volumes 210. For each virtual volume, the storage monitoring agent 300 collects the virtual volume ID, the capacity, the use capacity, the use capacity of each type of storage device (SSD use capacity, SAS use capacity, and SATA use capacity), and the ID of the pool to which the virtual volumes belong. The agent information collecting part acquires these collected values from the storage monitoring agent 300 and stores the acquired values in the table T12.

FIG. 11 is an explanatory diagram showing an example of a structure of the virtual machine constitution/capacity information table T13 included in the resource constitution/capacity information 421. The table T13 manages the constitutions and capacities of the virtual machines 100. For each virtual machine, the storage monitoring agent 300 collects the virtual machine ID, the user ID, the capacity, the use capacity, the virtual volume ID, and the use capacity of each type of storage device (SSD use capacity, SAS use capacity, and SATA use capacity). The agent information collecting part acquires these collected values from the storage monitoring agent 300 and stores the acquired values in the table T13.

FIG. 12 is an explanatory diagram showing an example of a structure of the page constitution information table T14 included in the resource constitution/capacity information 421. The table T14 manages the information on page constitutions. For each page, the storage monitoring agent 300 collects the page ID, the type of storage device to which the page belongs, the ID of the virtual machine to which the page is allocated, the ID of the virtual machine that uses the page, and the pool ID. The agent information collecting part acquires these collected values from the storage monitoring agent 300 and stores the acquired values in the table T14.

FIG. 13 is an explanatory diagram showing an example of a structure of the pool performance information table T15 included in the resource performance information 420. The table T15 manages the information on the pool performances. For each pool, the storage monitoring agent 300 collects the pool ID and the allowable IOPS of each type of storage device. The agent information collecting part acquires these collected values from the storage monitoring agent 300 and stores the acquired values in the table T15.

FIG. 14 is an explanatory diagram showing an example of a structure of the virtual machine performance information table T16 included in the resource performance information 420. The table T16 manages the information on the performances of the virtual machines 100. For each virtual machine, the storage monitoring agent 300 collects the virtual machine ID and the response performance of each virtual disk. The agent information collecting part acquires these collected values from the storage monitoring agent 300 and stores the acquired values in the table T16.

FIG. 15 is an explanatory diagram showing an example of a structure of the page performance information table T17 included in the resource performance information 420. The table T17 manages the information on the page performances. For each page, the storage monitoring agent 300 collects the page ID and the access characteristics (e.g., average IOPS). The agent information collecting part acquires these collected values from the storage monitoring agent 300 and stores the acquired values in the table T17.

FIG. 16 is an explanatory diagram showing an example of a structure of the table T18 of storage device performance information by pool tier, which is included in the resource performance information 420. The table T18 manages the performance of each type of storage device forming each tier of the corresponding pool 220. For each type of storage device, the storage monitoring agent 300 collects a basic response performance. The agent information collecting part acquires the basic response performance of each type of storage device from the storage monitoring agent 300 and stores the acquired basic response performances in the table T18.

FIG. 17 is an explanatory diagram showing an example of a structure of the volume performance information table T19 included in the resource performance information 420. The table T19 manages the information on the performances of the pool volumes 232. For each volume, the storage monitoring agent 300 collects the allowable IOPS. The agent information collecting part acquires the allowable IOPS from the storage monitoring agent 300 and stores the acquired allowable IOPS in the table T19.

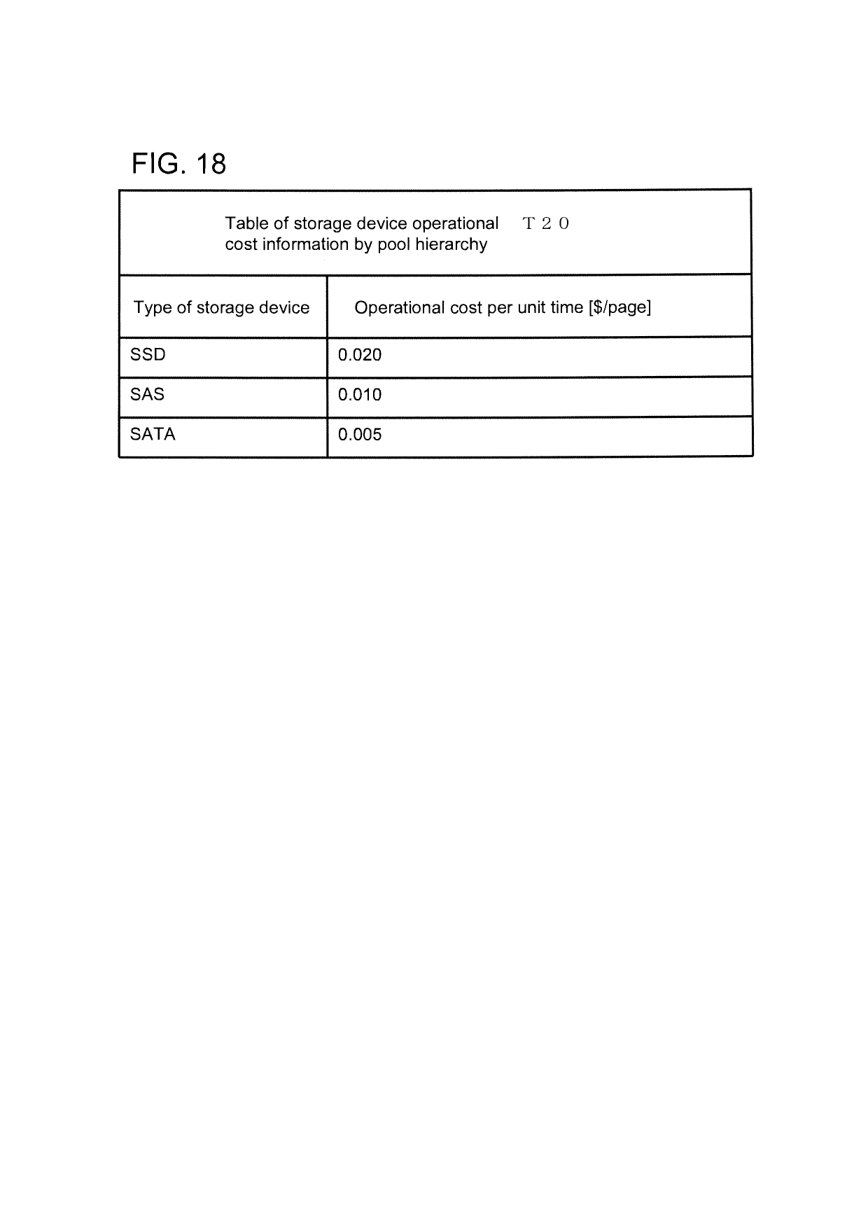

FIG. 18 is an explanatory diagram showing an example of a structure of a table T20 of storage device operational cost information by pool tier, which is included in the operational cost information 426. The table T20 manages the information on the operational cost of each type of storage device. For example, as shown in FIG. 18, the operational cost per unit time and per page unit cost is managed for each type of storage device. The administrator configures the operational costs in the table T20. The operational costs are configured with due consideration of, for example, labor costs, costs for installing the storage apparatuses, power consumption, and the like. However, any methods can be used for determining the operational costs or storing the operational costs in the table T20.

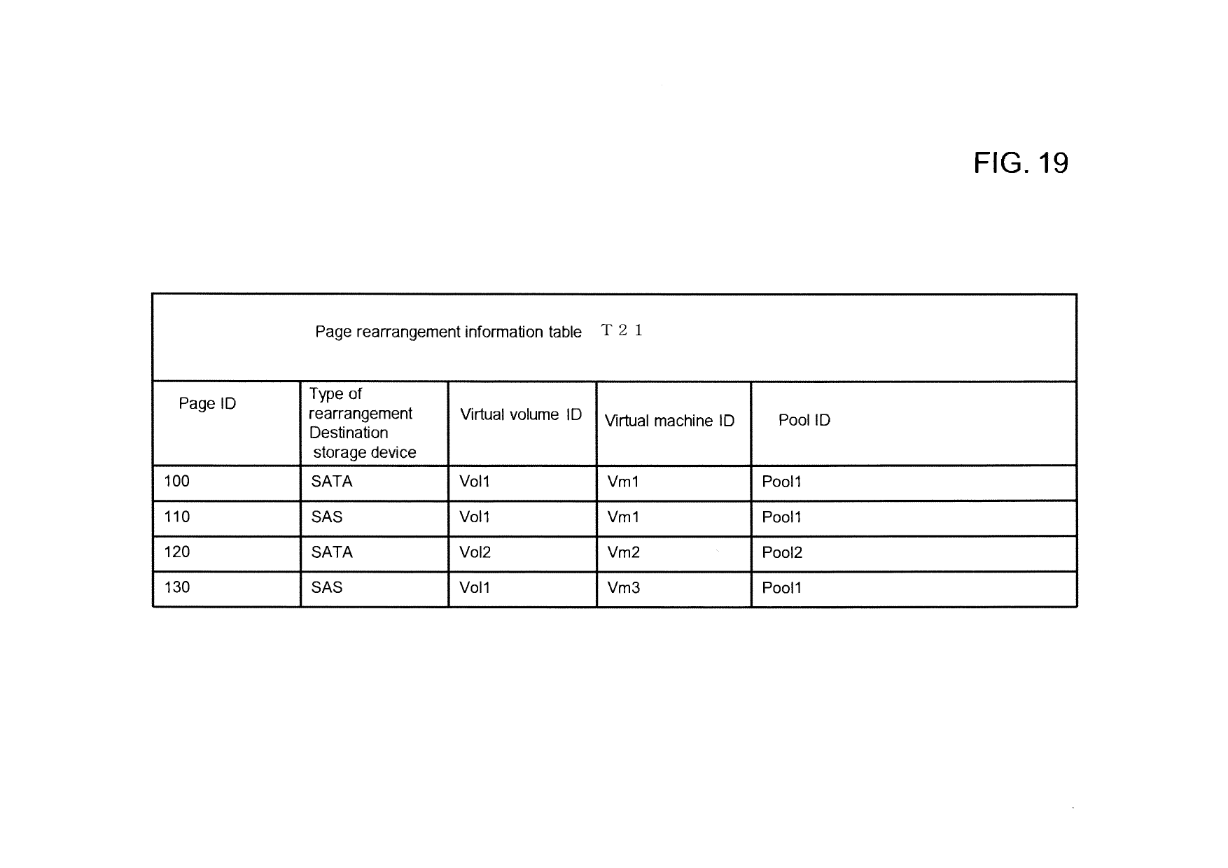

FIG. 19 is an explanatory diagram showing an example of a structure of a page rearrangement information table T21 included in the page rearrangement information 428. The table T21 manages the tiers corresponding to the page arrangement destinations. The page arrangement computing part 411 calculates the arrangement destination of each page, based on the resource performance information 420, the resource constitution/capacity information 421, the virtual machine performance plan information 422, and the virtual machine performance plan change information 425. The page arrangement computing part 411 stores calculation results (the page IDs, the types of storage devices corresponding to the rearrangement destinations, the virtual volume IDs, the virtual machine IDs, and the pool IDs) in the table T21.

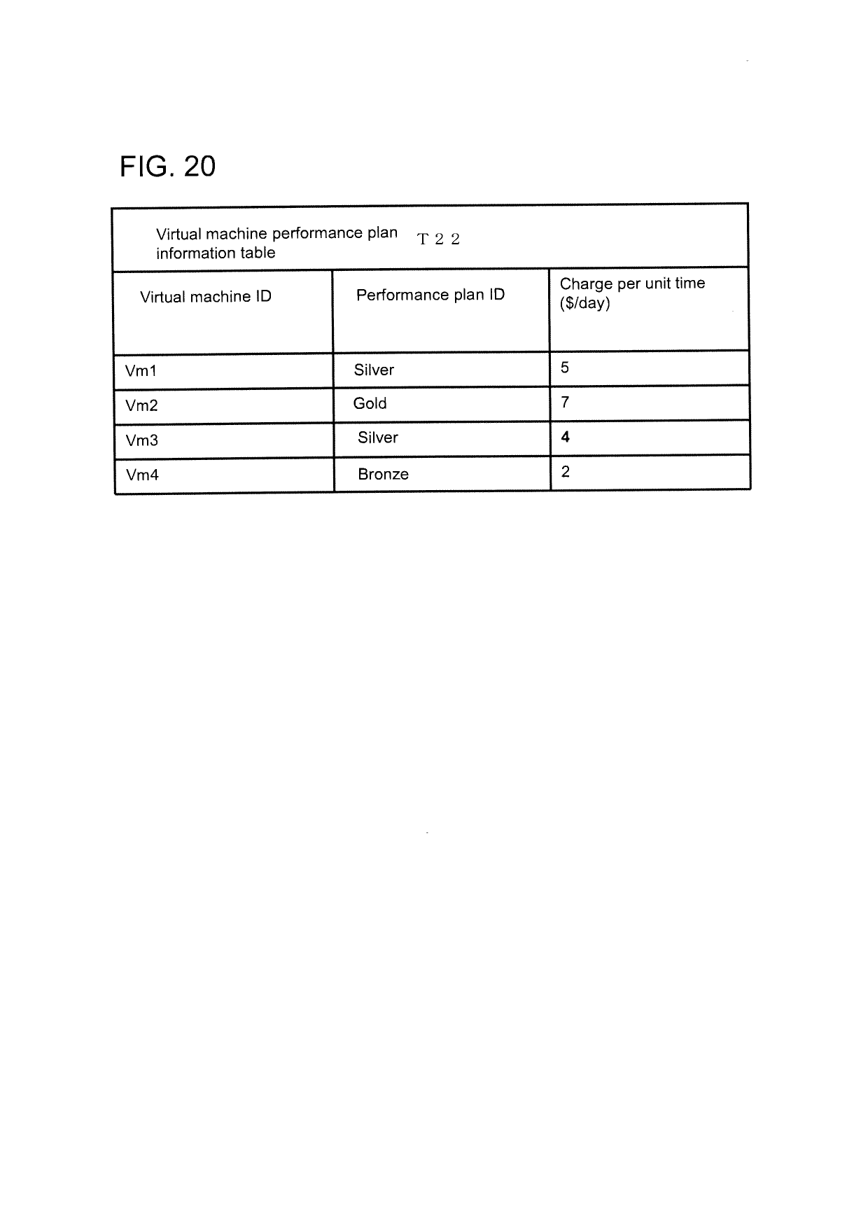

FIG. 20 is an explanatory diagram showing an example of a structure of the virtual machine performance plan information table T22 included in the virtual machine performance plan information 422. The table T22 manages the performance plans and fees applied to the virtual machines 100. For example, as show in FIG. 20, the virtual machine IDs, the performance plan IDs, and the fees per unit time are stored in the table T22. Initial information is registered by the administrator. The page arrangement computing part 411 updates the performance plan IDs and the fees per unit time.

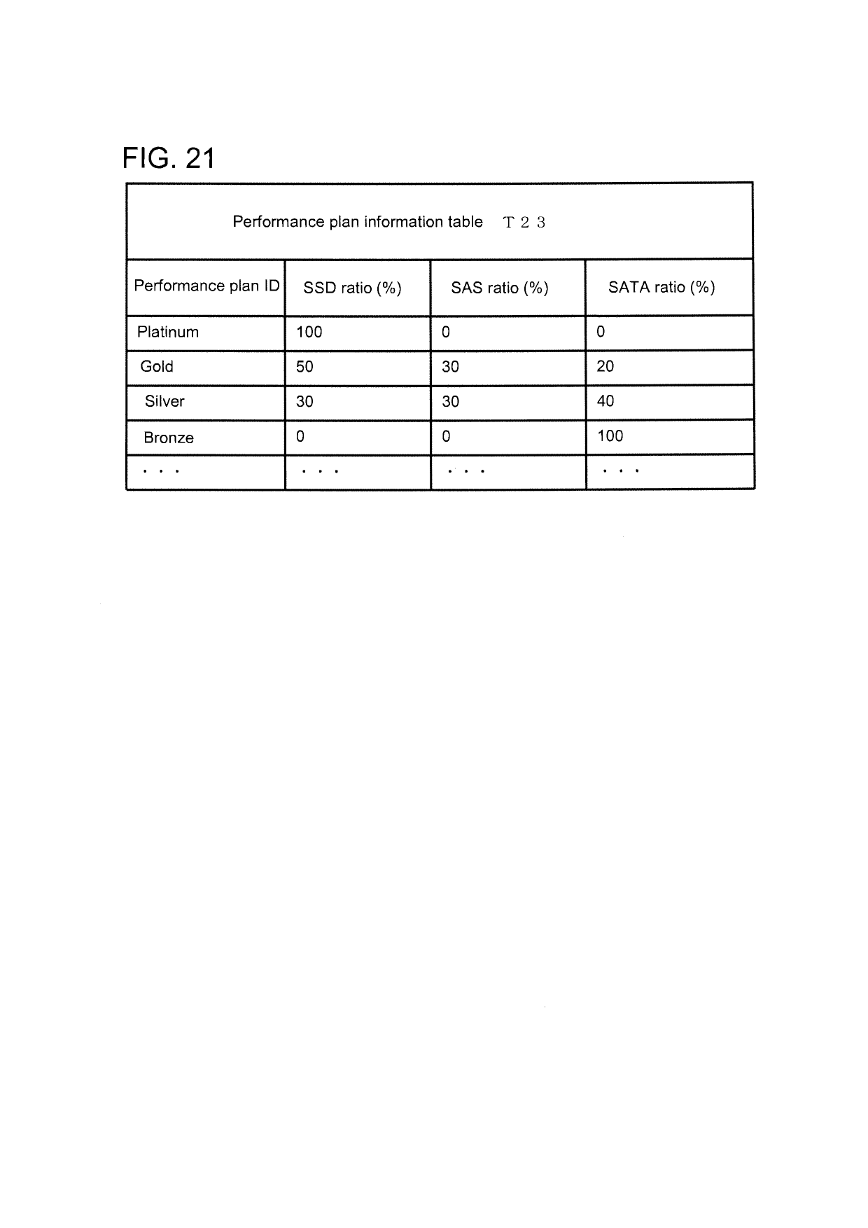

FIG. 21 is an explanatory diagram showing an example of a structure of a performance plan information table T23 included in the performance plan information 423. The table T23 manages contents of the performance plans. For example, as shown in FIG. 21, a usage ratio of each type of storage device is stored for each performance plan. Any methods can be used for storing values in the performance plan information table T23. The administrator can configure values in the table T23. Even in the tables in which the administrator can configure the values (e.g., the tables T20, T23, etc.), the values may be configured automatically by the management server 40 or other types of computers that are not shown.

The performance plans shown in FIG. 21 are now described briefly. The virtual machine 100 to which the most expensive platinum plan (also referred to as “first performance plan”) is applied can constitute the virtual volumes 210 with the high-performance storage devices 230A (e.g., SSD) only. The data that are used by the virtual machine 100 to which the platinum plan is applied are all stored in the high-performance storage devices 230A.

With regard to the second most expensive gold plan (also referred to as “second performance plan”), the high-performance storage devices 230A can be allocated to 50% of the total capacity of the virtual volumes 210, the medium-performance storage devices 230B to 30% of the total capacity of the virtual volumes 210, and the low-performance storage devices 230C to 20% of the total capacity of the virtual volumes 210. When the use capacities of the virtual volumes 210 are equal to or lower than half the total capacity, all of the data of the virtual machine 100 to which the gold plan is applied can be stored in the high-performance storage devices 230A.

With regard to the comparatively cheap silver plan (also referred to as “third performance plan”), the high-performance storage devices 230A can be allocated to 30% of the total capacity of the virtual volumes 210, the medium-performance storage devices 230B to 30% of the total capacity of the virtual volumes 210, and the low-performance storage devices 230C to 40% of the total capacity of the virtual volumes 210. When the use capacities of the virtual volumes 210 are more than 60% of the total capacity of the virtual machine 100 to which the silver plan is applied, the response performance becomes degraded because the low-performance storage devices 230C are allocated to the virtual volumes 210.

According to the example, in the least expensive bronze plan (also referred to as “fourth performance plan”), only the low-performance storage devices 230C are allocated to the virtual volumes 210. Even when the use capacities of the virtual volumes 210 increase in the virtual machine 100 to which the bronze plan is applied, the response performance remains substantially constantly low.

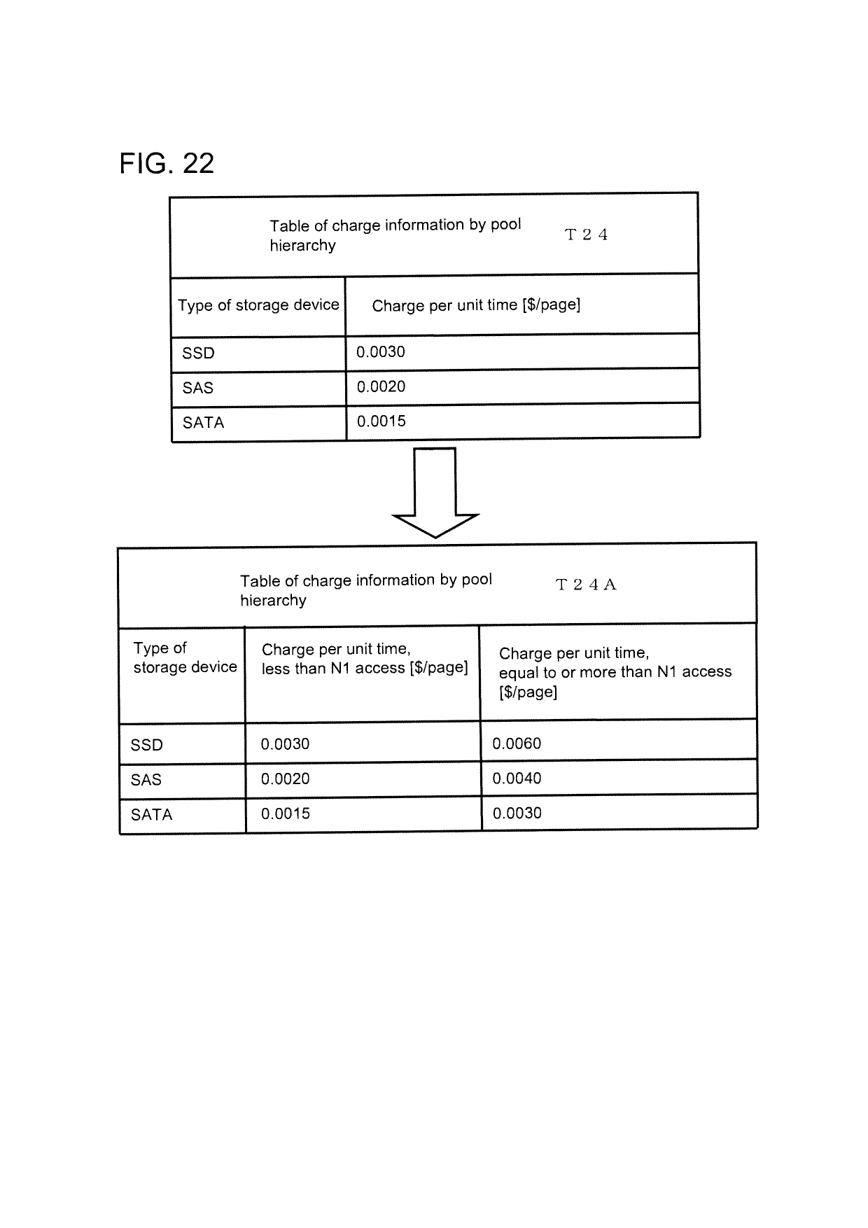

FIG. 22 is an explanatory diagram showing an example of a structure of a table T24 of fee information by pool tier, which is included in the fee information by pool tier 424. The table T24 manages the fees obtained in the respective tiers. For example, as shown in FIG. 22, for each type of storage device, the fee per page and per unit time is stored in the table T24. Any methods can be used for storing values to the table T24 of fee information by pool tier. For instance, the administrator can configure the values in the table T24.

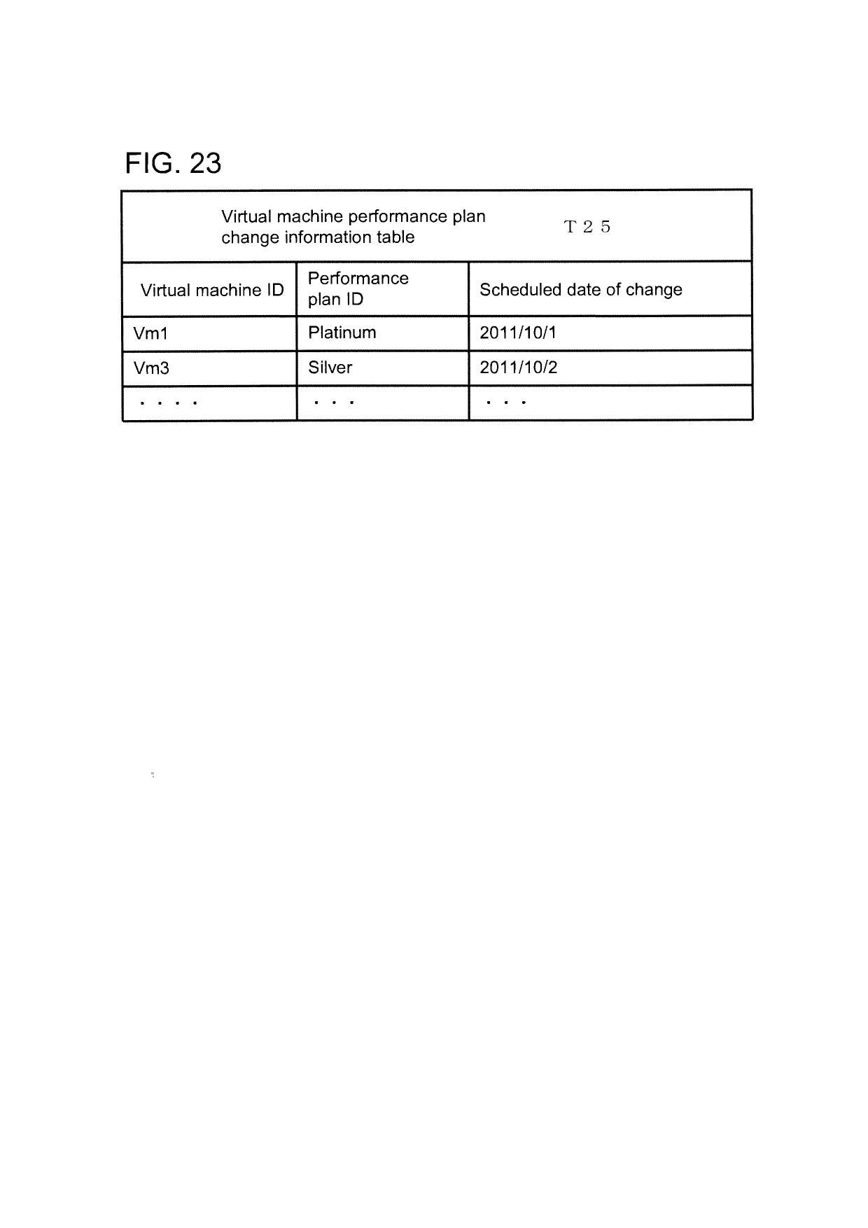

FIG. 23 is an explanatory diagram showing an example of a structure of the virtual machine performance plan change information table T25 included in the virtual machine performance plan change information 425. The table T25 manages information related to the changes of the performance plans applied to the virtual machine 100.

The plan change requesting part 405 generates the virtual machine performance plan change information based on information input by the user, and stores the virtual machine performance plan change information in the table T25. The change canceling part 406 deletes the virtual machine performance plan change information stored in the table T25, in accordance with the information input by the user.

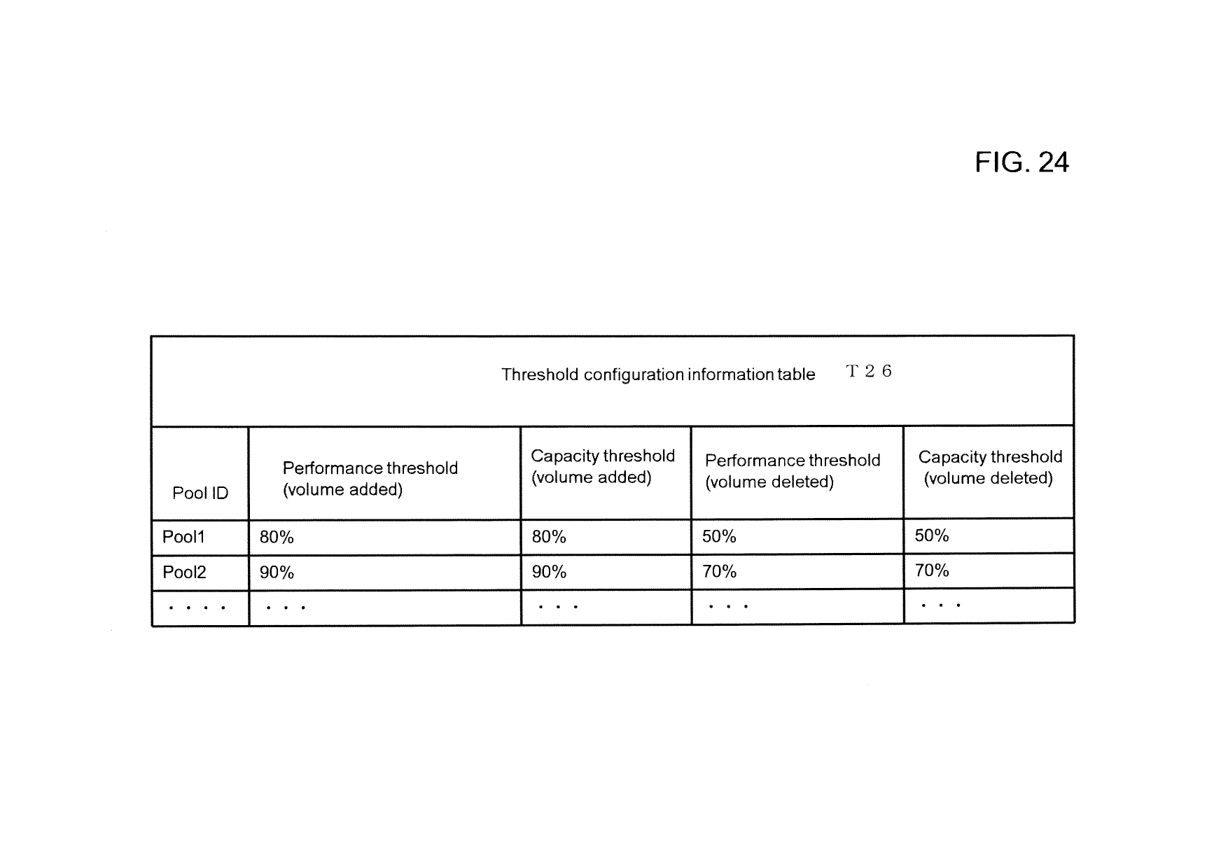

FIG. 24 is an explanatory diagram showing an example of a structure of a table T26 of performance/capacity threshold configuration information by pool, which is included in the performance/capacity threshold configuration information by pool 427. The table T26 manages thresholds for sending an alert to the administrator to change the constitution of the pool 220. Examples of types of the thresholds include thresholds related to the performances and thresholds related to the capacities. The thresholds related to the performances can be defined as, for example, ratios of the performances to the allowable IOPS. The threshold types also include thresholds for adding the pool volumes 232 to the tiers and thresholds for getting rid of the pool volumes 232 from the tiers. Therefore, there are four types of thresholds: performance threshold (adding volume), capacity threshold (adding volume), performance threshold (deleting volume), and capacity threshold (deleting volumes). These four types of thresholds are registered in the table T26 by, for example, the administrator.

Processes executed by the management software 400 are described with reference to the flowcharts shown in FIGS. 25 to 36.

FIG. 25 is a flowchart showing a procedure carried out by the agent information collecting part included in the management software 400. The procedure shown in FIG. 25 is started on a regular basis according to a programmed schedule or at the request of the management client 50 upon instruction operated by the user.

Each of the following processes can be explained using the computer programs as the subject of the processes or using the management server as the subject of the processes. For convenience, the present example describes each of the processes using the management server as the subject of the processes.

The management server 40 acquires predetermined information from the storage monitoring agent 300 (S10), and stores the acquired predetermined information in each of predetermined tables (S11).

Specifically, the management server 40 acquires the pool constitution/capacity information and stores the information in the pool constitution/capacity information table T10. The management server 40 then acquires the volume constitution/capacity information from the storage monitoring agent 300 and stores the information in the volume constitution/capacity information table T11. The management server 40 acquires the virtual volume constitution/capacity information from the storage monitoring agent 300 and stores the information in the virtual volume constitution/capacity information table T12.

Further, the management server 40 acquires the virtual machine constitution/capacity information from the storage monitoring agent 300 and stores the information in the virtual machine constitution/capacity information table T13. The management server 40 acquires the page constitution information from the storage monitoring agent 300 and stores the information in the page constitution information table T14. The management server 40 acquires the pool performance information from the storage monitoring agent 300 and stores the information in the pool performance information table T15.

Moreover, the management server 40 acquires the volume performance information from the storage monitoring agent 300 and stores the information in the volume performance information table T19. The management server 40 acquires the virtual machine performance information from the storage monitoring agent 300 and stores the information in the virtual machine performance information table T16. The management server 40 acquires the page performance information from the storage monitoring agent 300 and stores the information in the page performance information table T17.

Finally, the management server 40 acquires the storage device performance information by pool tier from the storage monitoring agent 300 and stores the information in the table T18 of storage device performance information by pool tier, and ends the present process.

FIG. 26 is a flowchart showing a procedure carried out by the virtual machine information display part 401 included in the management software 400. The procedure shown in FIG. 26 is started at the request of the management client 50 upon instruction operated by the user. Note that, when starting this process, the user ID for uniquely identifying the user is provided as an input.

The management server 40 acquires predetermined information items from a predetermined table (S20). The management server 40 then associates the acquired information items with each other and displays the information items on the screens G10 and G11 (S21).

This process is now described specifically. The management server 40 acquires the virtual machine ID, the capacity, and the use capacity that correspond to the virtual machine having the input value “user ID” from the virtual machine constitution/capacity information table T13. The management server 40 then acquires a disk response performance for each virtual machine ID from the virtual machine performance information table T16.

The management server 40 acquires, from the virtual machine performance plan information table T22, the performance plan ID and the fee per unit time for each virtual machine ID. The management server 40 acquires the performance plan ID for each virtual machine ID from the virtual machine performance plan change information table T25.

The management server 40 associates the acquired information items with each other and displays the information items on the screens G10 and G11. With regard to the virtual machines, the performance plan IDs of which can be acquired, the management server 40 displays the cancel button on the screen G10. With regard to the virtual machines, the performance plan IDs of which cannot be acquired, the management server 40 displays the change button.

The management server 40 determines whether the change button shown in the screen G10 of FIG. 5 is pressed or not (S22). When the user presses the change button (S22: YES), the management server 40 starts a plan change screen display process, which is described hereinafter (S23).

When the change button shown in the screen G10 is not pressed (S22: NO), the management server 40 determines whether the cancel button shown in the screen G10 is pressed or not (S24). When the cancel button is pressed (S24: YES), the management server 40 starts a cancellation process.

Subsequent to step S23 or when the result of step S24 is determined to be NO or when the cancellation process is started, the management server 40 ends this process.

FIG. 27 is a flowchart showing a procedure carried out by the plan change screen display part 402 included in the management software 400. The procedure shown in FIG. 27 is started at the request of another process started upon instruction from the user. Note that, when starting this process, the virtual machine IDs for uniquely identifying the virtual machines are provided as inputs.

The management server 40 acquires predetermined information from a predetermined table (S30). The management server 40 predicts the response performances based on the acquired information (S31), and displays the predictive response performances on the screen G10 (S32).

This process is now described specifically. The management server 40 acquires a list of performance plan IDs from the performance plan information table T23. The management server 40 acquires the performance plan IDs and the fees that correspond to the virtual machine IDs from the virtual machine performance plan information table T22. The management server 40 acquires the capacities and the use capacities that correspond to the virtual machine IDs from the virtual machine constitution/capacity information table T13. The management server 40 displays the acquired information (the performance plans, capacities, use capacities, and fees) on the screen G10.

Next, the management server 40 starts the predictive response performance calculating part 403 and acquires the predictive response performance corresponding to each use capacity. The management server 40 displays changes in the predictive response performance for each usage, in the form of a chart, as shown in the region G113 on the screen G11 shown in FIG. 5.

The management server 40 determines whether the user operates the pull-down menu GP110 of the screen G11 shown in FIG. 5 and instructs to change the performance plan (S33). When the user does not operate the pull-down menu GP110 (S33: NO), the management server 40 ends this process. When the user operates the pull-down menu GP110 (S33: YES), the management server 40 displays the screen having the changed performance plan (S34). The management server 40 further determines whether the change of the performance plans is requested (S35). For example, the management server 40 determines whether the user presses the plan change button GP115 of the screen G11.

When the change of the performance plan is requested (S35: YES), the management server 40 starts a plan change request process, which is described hereinafter (S36). When the change of the performance plan is not requested (S35: NO), the management server 40 ends this process.

The process is now described specifically. The management server 40 acquires the performance plan ID from the selection state of the pull-down menu GP110. The management server 40 then starts the fee calculating part 404 to acquire the fee after the change of the plan. The management server 40 starts the predictive response performance calculating part 403 to acquire the predictive response performance for each use capacity after the change of the plan. Thereafter, the management server 40 displays the predictive response performance for each use capacity after the change of the plan, in the form of a chart, as shown in the region GP114 on the screen G11 (S34). The management server 40 then waits for the user to operate the plan change button GP115 (S35).

FIG. 28 is a flowchart showing a procedure carried out by the predictive response performance calculating part 403 included in the management software 400. The procedure shown in FIG. 28 is started at the request of another process started upon instruction from the user. Note that, when starting this process, the virtual machine IDs for uniquely identifying the virtual machines and the performance plan IDs for uniquely identifying the performance plans are provided as inputs.

First, the management server 40 acquires a ratio of each type of storage device corresponding to the performance plan (S40). The management server 40 then acquires the capacities and use capacities of the virtual machines from the virtual machine constitution/capacity information table T13 (S41). The management server 40 calculates the maximum number of usable pages for each type of storage device (S42). The maximum number of pages that can use the storage devices can be obtained by multiplying the maximum capacity that can be used by each virtual machine by the ratio of the storage devices, and dividing the resultant value by the page size (=maximum capacity*ratio/page size). Note that the page size is a given fixed value.

The management server 40 rearranges the pages in descending order of access characteristics and acquires the basic response performance of each type of storage device (S43).

Specifically, the management server 40 acquires a list of page IDs corresponding to the virtual machine IDs from the page constitution information table T14. The management server 40 acquires a list of access characteristics corresponding to the list of page IDs from the page performance information table T17. The management server 40 then sorts the access characteristics in descending order of values. The management server 40 acquires the basic response performance for each type of storage device from the table T18 of storage device performance information by pool tier.

The management server 40 predicts an IOPS distribution (S44). The management server 40 calculates the response performance predictive value from the predictive IOPS distribution and the basic response performance of each type of storage device (S45). The management server 40 then returns the calculated predictive values to the caller of this process.

Specifically, for each type of storage device, the management server 40 predicts the response performance by type by aggregating the IOPS of the pages and multiplying the summary value by the value of the basic response performance.

Combinations of the use capacity and the response time, such as (10 [GB], 3 [ms]), (20 [GB], 3 [ms]), and (30 [GB], 5 [ms]), are returned to the caller of the process.

FIG. 29 is a flowchart showing a procedure carried out by the fee calculating part 404 included in the management software 400. The procedure shown in FIG. 29 is started at the request of another process performed upon instruction from the user. Note that, when executing this process, the virtual machine IDs and the performance plan IDs are provided as inputs.

The management server 40 acquires the capacities corresponding to the virtual machine IDs from the virtual machine constitution/capacity information table T13 (S50). The management server 40 then acquires the ratio of each type of storage device corresponding to each performance plan ID (SSD ratio, SAS ratio, and SATA ratio) from the performance plan information table T23 (S51).

The management server 40 acquires the fee per unit time of each type of storage device from the table T24 of fee information by pool tier (S52). The management server 40 then calculates the fee after the change of the plan and returns the obtained fee to the caller (S53).

The fee after the change of the plan can be obtained by summing up the fees for each type of corresponding storage devices. The fee of a certain type of storage device can be obtained by multiplying the number of pages using this type of storage device by the page unit cost per unit time.

The number of pages using the certain type of storage device is obtained by multiplying the ratio of this type by the capacity that can be used by the virtual machine (maximum capacity) and then dividing the resultant value by the page size (the number of page=(capacity*ratio)/page size). The fee for using this type of storage device can be obtained by multiplying the number of pages by the fee per unit time (=the number of pages*fee per unit time).

The fee after the change of the performance plan can be obtained by calculating the fee for each type of storage device and then finally summing up the fees of all types of the storage devices.

FIG. 30 is a flowchart showing a procedure carried out by the plan change requesting part 405 included in the management software 400. The procedure shown in FIG. 30 is started from the change screen display part 402 upon instruction from the user. Note that, when executing this process, the virtual machine IDs and performance plan IDs are provided as inputs.

The management server 40 calculates a scheduled date of change for changing the performance plan (S60). In the present example, for instance, the scheduled date of change is 3 days after the current time/date. For instance, when the current time/date is Jan. 10, 2011 the scheduled date of change is Jan. 13, 2011.

The management server 40 stores the virtual machine IDs, the performance plan IDs, and the scheduled date of change in the virtual machine performance plan change information table T25 (S61) and ends this process.

FIG. 31 is a flowchart showing a procedure carried out by the pool information display part 407 included in the management software 400. The procedure shown in FIG. 31 is started at the request of the management software 400 upon instruction from the user. Note that, when executing this process, the pool IDs are provided as inputs.

The management server 40 calculates the operational cost of the target pool designated by the pool ID, based on predetermined information acquired from a predetermined table (S70).

This process is now described more specifically. The management server 40 acquires the total capacity of the target pool designated by the pool ID and the capacity of each type of storage device from the pool constitution/capacity information table T10. The management server 40 further acquires the allowable IOPS of each type of storage device from the pool performance information table T15 and acquires the operational cost per unit time of each type of storage device from the table T20 of storage device operational cost information by pool tier.

The management server 40 calculates the operational cost per unit time for each type of storage device. By dividing the capacity of each storage device by the page size, the number of pages used by each storage device can be obtained. By multiplying the resultant number of pages by the page operational cost per unit time, the operational cost of a certain type of storage device can be obtained (the operational cost of a certain type of storage device=(capacity of this storage device/page size)*the operational cost per unit time of the pages of this storage device).

The cost per unit time of the target pool (total cost) can be obtained by summing up the operational costs of all types of the storage devices.

Next, the management server 40 starts the use capacity predictive value calculating part 408 to predict a change in the use capacity over time, for each type of storage device (S71).

The values obtained by the use capacity predictive value calculating part 408 are each, for example, time-series data of a combination of the time/date and the capacity. The SSD out of the plurality of types of storage devices is illustrated hereinafter as an example.

[SSD Predictive Use Capacities]

(Nov. 1, 2011, 30 GB)

(Nov. 2, 2011, 45 GB)

(Nov. 3, 2011, 30 GB)

(Nov. 4, 2011, 60 GB)

The management server 40 can display the changes in the use capacities over time of all types of the storage devices in the form of a chart. In so doing, the management server 40 also displays the capacity of each type of storage device corresponding to the target pool, on the chart.

Thereafter, the management server 40 starts the IOPS predictive value calculating part 409 to predict a change in the IOPS over time, for each type of storage device (S72). The values obtained by the IOPS predictive value calculating part 409 are each, for example, time-series data of a combination of the time/date and the IOPS. The SSD out of the plurality of types of storage devices is illustrated hereinafter as an example.

[SSD Predictive IOPS]

(Nov. 1, 2011, 6000)

(Nov. 2, 2011, 7000)

(Nov. 3, 2011, 5000)

(Nov. 4, 2011, 10000)

The management server 40 can display the changes in the IOPS over time for all of the storage devices in the form of a chart. In so doing, the management server 40 also displays the allowable IOPS of each type of storage device corresponding to the target pool, on the chart.

Next, the management server 40 starts the fee predictive value calculating part 410 to predict temporal changes in the fee for the pool and the fee of each type of storage device (S73).

The values obtained by the fee predictive value calculating part 410 are each, for example, time-series data of a combination of the time/date and the fee. The SSD out of the plurality of types of storage devices is illustrated hereinafter as an example.

[SSD Predictive Fees]

(Nov. 1, 2011, 17)

(Nov. 2, 2011, 22)

(Nov. 3, 2011, 17)

(Nov. 4, 2011, 34)

The management server 40 displays the temporal changes in the fee of each type of storage device and the temporal changes in the fee for the pool, in the form of a chart. In so doing, the operational cost of the target pool and the operational cost of each type of storage device are also displayed in the chart.

Thereafter, the management server 40 determines whether or not either the performance or the capacity exceeds a predetermined threshold (S74). This step is now described specifically. The management server 40 acquires, from the table T26 of performance/capacity threshold configuration information by pool, the performance threshold and capacity threshold for determining whether to add the pool volumes, as well as the performance threshold and capacity threshold for determining whether to delete the pool volumes. In the following description, a statement “(adding volume)” is added to the thresholds for determining whether to add the pool volumes, and “(deleting volume)” to the threshold for determining whether to delete the pool volumes.

Prior to the execution of step S74, the predictive value for a temporal change in the use capacity (the predictive use capacity) and the predictive value for a temporal change in the IOPS (the predictive IOPS) for each type of storage device are obtained for each determination time/date.

When the predictive capacity or the predictive IOPS corresponding to any of the determination times/dates satisfies the following (1) to (4), the management server 40 determines that the threshold is exceeded (S74: YES). The SSD is described as an example. The same calculation is performed with respect to the other types of storage devices (SAS and SATA).

SSD predictive use capacity>SSD capacity*capacity threshold(adding volume) (1)

SSD predictive use capacity<SSD capacity*capacity threshold(deleting volume) (2)

SSD predictive IOPS>SSD allowable IOPS*performance threshold(adding volume) (3)

SSD predictive IOPS<SSD allowable IOPS*performance threshold(deleting volume) (4)

When none of (1) to (4) described above are satisfied, the management server 40 determines that neither the performance nor the capacity exceeds the threshold (S74: NO), and ends this process.

When any one of (1) to (4) described above is established, the management server 40 displays the alert message GP200, as shown in the screen GP20 of FIG. 6. The alert message can include, for example, a content of the alert such as “change of constitution required” or a reason of the alert such as “the SSD usage has exceeded the threshold.”

The management server 40 determines whether or not the administrator wishes to change the constitution of the pool (S76). Specifically, the management server 40 determines whether or not the constitution change button GP206 of the screen G20 is pressed.

When the constitution change button GP206 is pressed (S76: YES), the management server 40 starts the pool constitution change screen display part 413 (S77) and ends this process. Note that, when starting the pool constitution change screen process, the maximum predictive use capacity value and the maximum predictive IOPS value are provided as inputs for each type of storage device. When the constitution change button GP206 is not pressed (S76: NO), this process is ended.

FIG. 32 is a flowchart showing a procedure carried out by the use capacity predictive value calculating part 408 included in the management software 400. The procedure shown in FIG. 32 is started from the pool information display part 407 upon instruction from the user. Note that, when executing this process, the pool IDs are provided as inputs.

The management server 40 calculates the use capacity predictive value for each type of storage device (S80). The management server 40 acquires the ratio of each type of storage device in the pool, from the performance plan information table T23 (S81). The management server 40 predicts the use capacity of the high-performance storage device (e.g., SSD) for each determination time/date and sums up the resultant values (S82). Similarly, the management data 40 predicts the use capacity of the medium-performance storage device (e.g., SAS) for each determination time/date and sums up the resultant values (S83). Similarly, the management server 40 predicts the use capacity of the low-performance storage device (e.g., SATA) for each determination time/date and sums up the resultant values (S84). Finally, the management server 40 returns the predicted result corresponding to each type of storage device to the caller (S85).

FIG. 33 is a flowchart showing a procedure carried out by the TOPS predictive value calculating part 409 included in the management software 400. This procedure is started from the pool information display part 407 upon instruction from the user. Note that, when executing this process, the pool IDs are provided as inputs.

From the virtual volume constitution/capacity information table T12, the management server 40 specifies the virtual volume 210 that uses the target pool. From the virtual machine constitution/capacity information table T13, the management server 40 specifies the virtual machine 100 that uses the specified virtual volume 210. From the page constitution information table T14, the management server 40 acquires the IDs of all of the pages used by the specified virtual machine 100 (S90).

The management server 40 acquires the access characteristics (average IOPS) of each page from the page performance information table T17. The management server 40 then sorts and stores the acquired access characteristics in descending order.

The management server 40 determines whether a temporal change in the use capacity of each type of storage device is already predicted or not (S92). When it is not predicted (S92: NO), the management server 40 executes the process described in FIG. 32 (S93).

When it is predicted (S92: YES) or after the completion of the process described in FIG. 32, the management server 40 predicts the number of use pages, for each type of storage device (S94). The number of use pages can be obtained by dividing the predictive use capacity by the page size.

The management server 40 predicts the IOPS for each type of storage device (S95). The management server 40 adds up the IOPS of all of the pages based on the IDs of the pages that are rearranged in descending order of access characteristics. The total of the IOPS of all of the pages corresponds to a total IOPS of a certain type of storage device in the target pool. The management server 40 performs this calculation for each type of storage device.

Finally, the management server 40 returns to the caller the total value of the predictive IOPS of all types of the storage devices obtained for each determination time/date (S96).

FIG. 34 is a flowchart showing a procedure carried out by the fee predictive value calculating part 410 included in the management software 400. The procedure shown in FIG. 34 is started from the pool information display part 407 upon instruction from the user. Note that, when executing this process, the pool IDs are provided as inputs.

The management server 40 determines whether a temporal change in the use capacity of each type of storage device is already predicted or not (S100). When it is not predicted (S100: NO), the management server 40 executes the process described in FIG. 32 (S101).

When it is predicted (S100: YES) or after the completion of the process described in FIG. 32, the management server 40 calculates the fee for each type of storage device (S102, S103, and S104). The management server 40 then returns the fee predictive value of each type of storage device to the caller (S105).

This process is now described specifically. The management server 40 acquires a list of virtual volume IDs corresponding to the target pool from the virtual volume constitution/capacity information table T12. The management server 40 acquires a fee per unit time of each type of storage device from the table T24 of fee information by pool tier. The management server 40 acquires, from the virtual machine constitution/capacity information table T13, the virtual machine IDs and the use capacity of each type of storage device that correspond to the list of virtual volume IDs.

When a temporal change in the use capacity of each type of storage device is predicted (S100: YES) or after the completion of the press described in FIG. 32, the management server 40 predicts the fee of each type of storage device as follows.

For instance, to describe the case of the SSD as an example, the predictive fee of the SSD can be obtained by dividing the use capacity predictive value of the SSD by the page size (i.e., the number of pages that use the SSD) and then multiplying the resultant value by the page unit cost of the SSD (S102). The calculation is performed similarly for the SAS and SATA (S103 and S104). The fee of the target pool can be predicted by summing up the fees corresponding to all types of the storage devices.

FIG. 35 is a flowchart showing a procedure carried out by the page arrangement computing part 411 included in the management software 400. The procedure shown in FIG. 35 is started on a regular basis according to a programmed schedule or started at the request of the management client 50 upon instruction operated by the user.

The management server 40 acquires predetermined information from a predetermined table (S110). Specifically, the management server 40 acquires a list of pools from the pool constitution/capacity information table T10. The management server 40 uses the virtual volume constitution/capacity information table T12 and the virtual machine constitution/capacity information table T13 to specify the virtual volumes and the virtual machine that uses each of the virtual volumes, for each of the pools described in the list of pools.

Furthermore, the management server 40 acquires, from the page constitution information table T14, a list of pages used by the target virtual machine, and acquires the access characteristics of each page from the page performance information table T17. The management server 40 further acquires, from the virtual machine performance plan change information table T25, the performance plan ID, the scheduled date of change, and the fee per unit time that correspond to the target virtual machine.

Subsequently, the management server 40 determines whether the current time is a scheduled date of implement (a scheduled time of implement) or not (S111). When the current time is not yet the scheduled date of implement (S111: NO), the management server 40 acquires the fee per unit time from the virtual machine performance plan information table T22 (S112).

When the current time reaches the scheduled date of implement (S111: YES), the management server 40 acquires the fee per unit time of the target virtual machine and the performance plan ID from the virtual machine performance plan change information table T25 (S113). The management server 40 deletes the information corresponding to the target virtual machine from the virtual machine performance plan change information table T25. The management server 40 rewrites the performance plan ID and the fee per unit time of the information corresponding to the target virtual machine into the performance plan ID and the fee per unit time after the change.

The management server 40 calculates the arrangement destination (rearrangement destination) of the pages used by the virtual machine, such that the fee becomes equal to or lower than the fee per unit time and that the response performance of the storage region used by the virtual machine becomes the maximum response performance (S114). The management server 40 stores the result of calculating the page arrangement destination in the page rearrangement information table T21.

Specifically, the management server 40 calculates the page rearrangement destination in a manner as to satisfy the following (condition 1) and (condition 2). The page arrangement destination may be calculated using other methods.

(Condition 1) Within Budget

Fee(budget amount)defined by performance plan≧Page unit cost of SSD*Number of pages used in SSD+Page unit cost of SAS*Number of pages used in SAS+Page unit cost of SATA×Number of pages used in SATA

(Condition 2) Response Performance Becomes the Maximum

The response performance of the storage region used by the virtual machine can be obtained from the following equation.

Response performance=((Basic response performance of SSD*Integrated value of average IOPS with respect to the use page of SSD)+(Basic response performance of SAS*Integrated value of average IOPS with respect to the use page of SAS)+(Basic response performance of SATA*Integrated value of average IOPS with respect to the use page of SATA)/Total value of average IOPS of all use pages

The management server 40 starts the page rearrangement execution part 412 (S115) and ends this process.

FIG. 36 is a flowchart showing a procedure carried out by the pool constitution change screen display part 413 included in the management software 400. The procedure shown in FIG. 36 is started from the pool information display part 407 upon instruction from the user. Note that, when executing this process, the pool IDs, predictive maximum IOPS of each type of storage device, and predictive maximum use capacity of the same are provided as inputs.

The management server 40 calculates the operational cost of each type of storage device and displays the calculated operational cost along with other information in the screen G21 shown in FIG. 7 (S120).

This step is now described specifically. The management server 40 acquires the capacity corresponding to the target pool and the capacity of each type of storage device from the pool constitution/capacity information table T10, and acquires the allowable IOPS of each type of storage device from the pool performance information table T15. The management server 40 acquires the fee per unit time of each type of storage device from the table T20 of storage device operational cost information by pool tier (the cost per unit time of the SSD, the operational cost per unit time of the SAS, and the operational cost per unit time of the SATA). The management server 40 then calculates the operational cost of each type of storage device and the operational cost of the entire pool.

The management server 40 displays the allowable IOPS, the operational cost, the predictive maximum IOPS, and the predictive maximum use capacity of each type of storage device, on the screen G21. Note that, at this moment, the region GP211 for displaying the pool information before the change of the constitution and the region GP212 for displaying the pool information after the change of the constitution display the same contents, the regions GP211 and GP212 being shown in FIG. 7.

The management server 40 acquires predetermined thresholds corresponding to the target pool from the table T26 of performance/capacity threshold configuration information by pool. The predetermined thresholds are the thresholds described above, which are the performance threshold (adding volume), capacity threshold (adding volume), performance threshold (deleting volume), and capacity threshold (deleting volume).

The management server 40 performs calculation of the following equations (S121). Hereinafter, the SSD described as an example. The calculation is performed similarly in the other storage devices such as the SAS and SATA.

### (Equation for Calculating the Amount of Increase in the Performance)

Amount of increase in allowable IOPS of SSD=Predictive maximum IOPS*Performance threshold(adding volume)−SSD allowable IOPS

### (Equation for Calculating the Amount of Capacity Added)

Capacity to be added to SSD=Predictive maximum SSD use capacity*Capacity threshold(adding volume)−SSD capacity

The management server 40 refers to the volume constitution/capacity information table T11 and the volume performance information table T19 to acquire the candidates for the pool volumes that can be added to the storage tiers in which the performances or capacities need to be added (S122).

The management server 40 further calculates the operational cost for each of the pool volume candidates, rearranges the pool volume candidates in ascending order of operational costs, and displays the results in the additional candidate volume display region GP213 of the screen G21.

Note that the operational costs of the pool volume candidates can be obtained by dividing the capacity of each pool volume candidate by the page size to calculate the number of pages and then multiplying the number of pages by the fee of each type of storage device (the fee per unit time/per page).

The management server 40 calculates whether the pool volumes can be eliminated from the target pool or not (S122), and acquires the candidates for the pool volumes that can be eliminated (S123).

The SSD is now described as an example. The management server 40 performs calculation of the following equations. The calculation is performed similarly for the SAS and SATA.

### (Equation for Calculating Excess Performance)

Excess allowable IOPS of SSD=Allowable IOPS of SSD−Predictive maximum IOPS of SSD*Performance threshold(deleting volume)

### (Equation for Calculating Excess Capacity)

Excess capacity of SSD=SSD capacity−Predictive maximum use capacity of SSD*Capacity threshold(deleting volume)

The management server 40 acquires a list of the pool volume candidates to be deleted, from the volume constitution/capacity information table T11. The management server 40 acquires the allowable IOPS corresponding to the pool volume candidates to be deleted, from the volume performance information table T19. The management server 40 calculates the operational costs of the pool volume candidates to be deleted, and displays the calculated operational costs in the deleted volume candidate display region GP214 of the screen G21.

The management server 40 determines whether or not the administrator instructs to add or delete the pool volumes (S125). When the administrator does not wish to add or delete the pool volumes, this process is ended.

When the administrator instructs to add or delete the pool volumes (S125: YES), the management server 40 updates the contents displayed in the region GP212 of the screen G21 that displays the pool information after the change of the constitution (S126).

The management server 40 determines whether or not the administrator presses the constitution change execution button GP215 (S127). When the constitution change execution button GP215 is pressed (S127: YES), the management server 40 instructs the pool controller 201 to change the constitution of the target pool (S128).

When the volume candidates to be added are selected, the management server 40 instructs the pool controller 201 to add the selected volumes to the target pool. When the volume candidates to be deleted are selected, the management server 40 instructs the pool controller 201 to get rid of the selected volumes from the target pool. When the constitution change execution button GP215 is not pressed (S127: NO), this process is ended.

In the present example configured as described above, the page unit cost is configured for each of the storage tiers 221 forming the pool 220, and the performance plan for determining the budget amount is configured for each of the virtual machines 100 sharing the virtual volume 210. Further, in the present example, the page arrangement destination is determined in order to obtain as high response performance as possible within a range of the budgets (fees) determined by the performance plans.

In the present example, therefore, the user who uses a virtual machine sharing the virtual volume with other virtual machines can be provided with a performance commensurate with the fee, improving convenience for and satisfaction of the user.

Moreover, in the present example, the user of the virtual machine is provided with the screens G10 and G11 for changing the performance plan. Therefore, the user of the virtual machine can change the performance plan according to need, improving the convenience.

In addition, in the present example, the screens G20 and G21 for displaying the current state and predictive values of the performance and capacity of the pool in chronological order are prepared for the administrator. The administrator, therefore, can easily determine whether the constitution of the pool needs to be changed or not. This improves the efficiency and usability of the management tasks.

Note that the present invention is not limited to the embodiment described above and can be modified in various ways without departing from the scope of the present invention. In the example, the virtual machines are used to exemplify the “host computers,” but physical computers may be used instead.

### REFERENCE SINGS LIST

1, 10 Virtualization server
2, 20 Storage apparatus
3, 30 Information collection server
4, 40 Management server
100 Virtual machine
210 Virtual volume
220 Pool
221 Storage tier
232 Pool volume
230 Storage device

1. A management apparatus for managing a computer system including a host computer and a storage apparatus, the storage apparatus having a virtual logical volume to be provided to the host computer and a pool having a plurality of storage tiers of different performances, and storage regions of the plurality of storage tiers being associated with a plurality of logical storage regions forming the virtual logical volume, the management apparatus comprising:
a tier fee storage part for storing fee information by tier, which manages, for each of the storage tiers, a fee required for using the storage regions of the plurality of storage tiers;
a fee plan information storage part for storing a predetermined fee plan information item of a plurality of prepared fee plan information items, the predetermined fee plan information item being associated with the host computer; and
an arrangement controller that associates the storage regions of the plurality of storage tiers with the logical storage regions on the basis of the predetermined fee plan information item, the fee information by tier, and a frequency of access by the host computer to the logical storage regions.

2. A management apparatus for a computer system according to claim 1, wherein the host computer is a virtual host computer that is virtually provided in plurality on a single physical computer, and
wherein the virtual host computers can share the virtual logical volume.

3. A management apparatus for a computer system according to claim 2, further comprising a pool state monitoring part for monitoring a state of the pool and displaying a monitoring result.

4. A management apparatus for a computer system according to claim 3, wherein the monitoring result includes a usage state of each of the storage tiers and alert information displayed when a value of the usage state reaches a previously-set threshold.

5. A management apparatus for a computer system according to claim 4, wherein the monitoring result includes information for associating, for each of the storage tiers, a usage amount of the host computer with a previously-set operational cost.

6. A management apparatus for a computer system according to claim 5, wherein the monitoring result includes a constitution change instructing part for changing a constitution of the pool for each of the storage tiers.

7. A management apparatus for a computer system according to claim 6, wherein the constitution change instructing part has at least either a list of additional candidates used when adding storage regions to each of the plurality of storage tiers or a list of deleted candidates used when deleting storage regions for each of the plurality of storage tiers.

8. A management apparatus for a computer system according to claim 7, wherein the arrangement controller controls a correlation between the logical storage regions and the storage regions of the plurality of storage tiers so as to obtain a maximum response performance of the virtual logical volume, within a range not exceeding an amount shown in the predetermined fee plan information item.

9. A management apparatus for a computer system according to claim 8, wherein the fee information by tier is configured such that the higher the frequency of access, the higher the fee.

10. A management apparatus for a computer system according to claim 9, wherein an upper limit to which the storage regions of the plurality of storage tiers can be used is configured in the fee plan information item, and the higher the fee plan information item, the higher the upper limit enabling the use of storage regions of a storage tier of a highest performance among the plurality of storage tiers.

11. A management apparatus for a computer system according to claim 1, further comprising a plan change part for changing the fee plan information item associated with the host computer to another fee plan information item.

12. A management apparatus for a computer system according to claim 11, wherein the plan change part changes the fee plan information item associated with the host computer to the other plan information item after a lapse of a predetermined time period since the other fee plan information item is selected.

13. A management method for using a management apparatus to manage a computer system including a host computer and a storage apparatus, the storage apparatus having a virtual logical volume to be provided to the host computer and a pool having a plurality of storage tiers of different performances, and storage regions of the plurality of storage tiers being associated with a plurality of logical storage regions forming the virtual logical volume,
wherein the management apparatus comprises:
a tier fee storage part for storing fee information by tier, which manages, for each of the storage tiers, a fee required for using the storage regions of the plurality of storage tiers; and
a fee plan information storage part for storing a predetermined fee plan information item of a plurality of prepared fee plan information items, the predetermined fee plan information item being associated with the host computer, and
wherein the management apparatus:
calculates a correlation between the logical storage regions and the storage regions of the plurality of storage tiers on the basis of the predetermined fee plan information item, the fee information by tier, and a frequency of access by the host computer to the logical storage regions;
monitors a usage state of the pool to determine whether a value of the usage state of the pool reaches a previously-set threshold; and
notifies a system administrator of the necessity of a change of a constitution of the pool, when the value of the usage state reaches the threshold.

14. A management method for a computer system according to claim 13, wherein, prior to the execution of the change of the constitution of the pool, and prior to the execution of the change of constitution, the management apparatus predicts the usage state of the pool after the change of the constitution and presents the predicted usage state and a current usage state to the system administrator.
